(19) United States
(12) Patent Application Publication
(10) Pub. No.: US 2007/0013983 A1
(43) Pub. Date: Jan. 18, 2007

(54) Holographic viewing device, and holographic viewing card incorporating it

(75) Inventors: Mitsuru Kitamura, Tokyo (JP); Kenji Ueda, Tokyo (JP); Koji Eto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DAI NIPPON PRINTING CO., LTD.

(21) Appl. No.: 11/480,470

(22) Filed: Jul. 5, 2006

(30) Foreign Application Priority Data
Jul. 4, 2005 (JP) P2005-194499
Jul. 4, 2005 (JP) P2005-194500
Jul. 6, 2005 (JP) P2005-198165

(51) Int. Cl. G03H 1/02

(52) U.S. Cl. 359/3

(57) ABSTRACT

The invention relates to a holographic viewing device that enable printing or the like to be directly applied to a transmission hologram substrate without recourse to any frame for supporting and reinforcing a transmission hologram, thereby simplifying construction while enhancing aesthetic and decorative attributes, and a holographic viewing card incorporating it. The holographic viewing device enables a given image or message to be viewed near the positions of point light sources upon viewing the point light sources through a hologram, and comprises a transparent substrate 41, a hologram-formation layer 42 and a printing layer 45. The hologram-formation layer 42 may be any one of a phase type diffractive optical element having a relief structure 43 on its surface, a phase type diffractive optical element having a refractive index profile in its layer, and an amplitude type diffractive optical element having a transmittance profile in its layer.

### BACKGROUND OF THE INVENTION

The present invention relates generally to a holographic viewing device and a holographic viewing card incorporating it, and more particularly to a message card that enables a given image or message to be viewed near the positions of point light sources upon viewing them through a hologram in the card. The present invention is also concerned with a holographic viewing card that is applicable to cards such as business cards or membership cards, toys or the like, and that can be printed on demand and has a holographic viewing portion.

Patent publication 1 has proposed holographic spectacles constructed as shown in the perspective view of FIG. 12(a). As shown, two transmission holograms 2 and 3 are fitted in the two-eye sections of a spectacle frame 1. When the spectacles are used to view a scene including such limited extent light sources 4, 5, 6 and 7 as shown in FIG. 12(b), the user would see it as if shown in FIG. 12(c) as an example. In other words, the user would see the pre-selected patterns “NOEL” 8, 9, 10 and 11 in place of the light sources 4, 5, 6 and 7 in the natural scene of FIG. 12(b). For the transmission hologram 2 and 3 having such characteristics, Fourier transform holograms (Fraunhofer holograms) of the aforesaid pattern “NOEL” designed as computer-generated holograms are used.

More recently, various devices using transmission holograms, including spectacles and round fans (uchiwa), have also been put forward (see, for instance, patent publication 3 and 4).

Such transmission holograms 2, 3 are fabricated in the form of phase holograms typically as follows.

FIG. 7(a) is a flowchart illustrative of one fabrication process for such transmission holograms (patent publication 2), and FIG. 7(b) is illustrative in schematic of that flowchart. At step 101, an input original image 21 is prepared. Then, at step 102, a Fourier transform image 22 of the input image is prepared using a computer. Then, at step 103, the Fourier transform image 22 is two- or multi-valued into a Fourier transform image 23. Then, at step 104, simulation is implemented for the image to be reconstructed. This simulation is to apply inverse Fourier transform to the multi-valued Fourier transform image 23 to obtain a reconstructed image 24, which is then used to check whether or not each of the above steps worked well. Then, at step 105, the multi-valued Fourier transform images obtained as mentioned above are laid out to the desired extent. For instance, four two-valued Fourier transform images 23 are arranged into a computer-generated hologram 25. Indeed, minimum unit images 23 are arranged 10 per row and 10 per column. Then, at step 106, a plate for copying the thus arranged computer-generated hologram 25 is fabricated, for instance, using a semiconductor process (photolithography plus etching). Finally, at step 107, the relief pattern of the original plate is copied to, for instance, an ultraviolet curable resin or the like. In this way, the transmission holograms 2, 3 are obtained.

Patent publication 3 comes up with a holographic viewing device comprising a Fourier transform hologram constructed as a computer-generated hologram, wherein an input original pattern reconstructed within a range of ⅔ or less, preferably ½ or less, of an image reconstruction region in that computer-generated hologram is recorded in the computer-generated hologram thereby making a pattern with less noticeable conjugate or higher-order images visible.
Patent Publication 1: U.S. Pat. No. 5,546,198
Patent Publication 2: JP-A 10-153943
Patent Publication 3: JP-A 2004-126535
Patent Publication 4: JP-A 2004-77548

With any one of these prior arts, however, it is still difficult to achieve integral formation of the transmission hologram with another member. For instance, a previously prepared transmission hologram is fitted in another member. This renders the fabrication process more complicated, and makes it difficult to find various applications.

Such holographic spectacles as depicted in FIG. 12(a) has a structure that the transmission holograms 2, 3 are fitted in the spectacle frame 1, requiring two parts, the transmission holograms 2, 3 and the spectacle frame 1. Plus, there is an additional processing for integrating two such parts together.

A holographic viewing device comprising one transmission hologram (e.g., monocle), too, has a structure that the transmission hologram is fitted in a frame, requiring processing for integrating two such parts together.

Besides, cards that incorporate these transmission holograms have difficulty using in various applications, because it is impossible for the user to print individual information on them or process digital images taken through cellular phones or digital cameras for printing on them.

### SUMMARY OF THE INVENTION

In view of such problems with the prior art as described above, one object of the present invention is to provide a holographic viewing device that enable printing or the like to be directly applied to a transmission hologram substrate without recourse to any frame for supporting and reinforcing a transmission hologram, thereby simplifying construction while enhancing aesthetic and decorative attributes, and a holographic viewing card incorporating it.

Another object of the present invention is to provide a holographic viewing card that can be printed on demand and has a transmission hologram integral therewith.

Yet another object of the present invention is to provide a holographic viewing device, wherein the relations of the number of pixels of an input image recorded in a computer-generated hologram to the recording sizes of pixels in the computer-generated hologram are so properly determined that a character string viewed in place of limited extent point light sources in a scene or in an overlapping fashion thereto can be viewed with good image quality.

According to the present invention, the above objects are achieved by the provision of a holographic viewing device that enables a given image or message to be viewed near the positions of point light sources upon viewing the point light sources through a hologram, characterized by comprising a structure including a transparent substrate, a hologram-formation layer and a printing layer.

In this embodiment of the invention, the hologram- formation layer may be constructed of any one of a phase type diffractive optical element having a relief structure on its surface, a phase type diffractive optical element having a refractive index profile in its layer, and an amplitude type diffractive optical element having a transmittance profile in its layer.

When the hologram-formation layer is constructed of the phase type diffractive optical element, it is preferably formed of a thermosetting resin, a thermoplastic resin, an ultraviolet curable resin, and an electron beam curable resin.

Preferably, the printing layer faces away from the hologram-formation layer with respect to the transparent substrate.

Preferably, the hologram-formation layer also faces away from a viewing side with respect to the transparent substrate.

Preferably, the hologram-formation layer is provided thereon with a protective layer.

Preferably, the printing layer is provided thereon with a message write layer.

Preferably in this case, the message write layer is provided thereon with a protective layer for protection of a portion of that layer which is spared.

The present invention also includes a holographic viewing card comprising any one of the holographic viewing devices as recited above.

According to the invention as recited above, there can be provided a holographic viewing device that enables a given image or message to be viewed near the positions of point light sources upon viewing the point light sources, wherein a printing layer is provided on a transmission hologram, so that any frame for fitting the transmission hologram is dispensed with without detrimental to the outside appearance of the hologram viewing device, thereby simplifying construction while enhancing aesthetic and decorative attributes, and a holographic viewing card incorporating it.

Another aspect of the present invention provides a holographic viewing card comprising a transparent substrate, and an image transform layer formed on said transparent substrate and comprising a transmission Fourier transform hologram area that enables a given image or message to be viewed near the positions of point light sources upon viewing the point light sources through a hologram and a non-hologram area that is not included in said transmission Fourier transform hologram area and does not function as a Fourier transform lens, characterized in that a printable receptor layer is formed on the side of said transparent substrate that faces away from said image transform layer or on said non-hologram area of said image transform layer.

According to this aspect of the present invention, there can be provided a holographic viewing card which, because of having a printable receptor layer, can have a variety of information, various images or the like printed thereon by various printers, etc. Further, this aspect of the present invention, because of comprising an image transform layer having said transmission Fourier transform hologram, makes it unnecessary to use or interleave another transmission Fourier transform hologram in place, ensuring efficient hologram viewing card fabrication.

Preferably in the holographic viewing card of the present invention, a primer layer is formed between said transparent substrate and said receptor layer, so that the adhesion between said transparent substrate and said receptor layer can be much more enhanced and ever higher quality is given to the holographic viewing card.

Preferably in the holographic viewing card of the present invention, said primer layer may contain a white pigment, so that an image printed on the receptor layer can be easier to view.

Another holographic viewing card of the present invention comprises a transparent substrate, an image transform layer comprising a transmission Fourier transform hologram area that enables a given image or message to be viewed near the positions of point light sources upon viewing the point light sources through a hologram and a non-hologram area that is not included in said transmission Fourier transform hologram area and does not function as a Fourier transform lens, and a protective layer formed on said transmission Fourier transform hologram area of said image transform layer, characterized in that a printable receptor layer is formed on said protective layer.

According to this aspect of the present invention, there can be provided a holographic viewing card which, because of having said receptor layer, can have a variety of information, various images or the like printed thereon by various printers, etc. In the third aspect of the present invention, said protective layer is provided, and said receptor layer is formed on that protective layer, so that an image or the like can also be printed on said transmission Fourier transform hologram area without detrimental to the Fourier transform lens function of that transmission Fourier transform hologram area (which enables the given image or message to be viewed near the positions of the point light sources upon viewing the point light sources through the hologram). Further, the third aspect of the present invention, because of comprising an image transform layer having said transmission Fourier transform hologram area, makes it unnecessary to use or interleave another transmission Fourier transform hologram in place, ensuring efficient hologram viewing card fabrication.

In the above holographic viewing card of the present invention, an image may have been printed on said receptor layer in a sublimation heat transfer mode, or in an ink jet mode. Further, an image may have been printed on said receptor layer in a thermal transfer mode or in an intermediate transfer mode. The formation of such a receptor layer makes it possible to print various images on the surface of the holographic viewing card by means of various printing techniques.

In the above holographic viewing card of the present invention, said image transform layer may be configured in the form of a surface phase type diffractive optical element layer in which said transmission Fourier transform hologram area has a relief structure on its surface. By using such a layer as said image transform layer, it is possible to achieve said transmission Fourier transform hologram area.

According to this aspect of the present invention, there can be provided a holographic viewing card which can have a variety of information, various images or the like printed thereon by various printers, etc. Further, this aspect of the present invention makes it unnecessary to use or interleave another transmission Fourier transform hologram in place, ensuring efficient hologram viewing card fabrication.

Another hologram viewing device of the present invention to accomplish the abovementioned objects comprises a computer-generated hologram constructed as a transmission Fourier transform hologram such that a given character string can be reconstructed and viewed near the positions of point light sources upon viewing the point light sources through a hologram, characterized by satisfying the following relations with respect to Nₓ, N_{y}, Wₓ and W_{y} where Nₓ is the number of pixels in a horizontal direction of input original image data recorded in said computer-generated hologram, N_{y} is the number of pixels in a vertical direction of input original image data recorded in said computer-generated hologram, Wₓ is the recording size of pixels of said computer-generated hologram in a horizontal direction, and W_{y} is the recording size of pixels of said computer-generated hologram in a vertical direction:
Wₓ×Nₓ≦2.828(mm) (1′)
W_{y×}N_{y}≦2.828(mm) (2′)
Wₓ≦λ/(0.004×NTₓ) (13)
W_{y}≦λ/(004×NT_{y}) (14)
Here, λ is the wavelength of the point light sources, NTₓ is the number of characters in the character string in a horizontal direction, and NT_{y} is the number of characters in the character string in a vertical direction.

Preferably in that case, the number of pixels Nₓ and N_{y} in the horizontal and vertical directions of the input original image data recorded in said computer-generated hologram satisfies the following relation:
Nₓ≦12×NTₓ (17)
N_{y}≦12×NT_{y} (18)

Preferably in said computer-generated hologram, unit computer-generated holograms, each comprising the Fourier transform image of the input original image, are lined up in given numbers in the horizontal and vertical directions.

In another holographic viewing device of the present invention, a given character string can be reconstructed and viewed near the positions of point light sources upon viewing the point light sources through a hologram, and Nₓ, N_{y}, Wₓ and W_{y}, where Nₓ is the number of pixels in a horizontal direction of input original image data for a character string recorded in said computer-generated hologram, N_{y} is the number of pixels in a vertical direction of the input original image data for the character string recorded in said computer-generated hologram, Wₓ is the recording size of pixels in a horizontal direction of said computer-generated hologram with the input original image data for the character string recorded in it, and W_{y} is the recording size of pixels in a vertical direction of said computer-generated hologram with the input original image data for the character string recorded in it, are determined in such a range as to satisfy the specific relations. It is thus possible to view, with good image quality, the character string in place of limited extent point light sources in a scene or in an overlapping fashion thereto.

Still other objects and advantages of the invention will in part be obvious and will in part be apparent from the specification.

The invention accordingly comprises the features of construction, combinations of elements, and arrangement of parts which Will be exemplified in the construction hereinafter set forth, and the scope of the invention will be indicated in the claims.

### BRIEF DESCRIPTION OF THE DRAWINGS

FIGS. 1(a) and 1(b) are a plan view and a sectional view of one embodiment of the holographic viewing card that comprises the holographic viewing device according to the present invention.

FIG. 2 is illustrative in schematic section of one example of the holographic viewing card according to the present invention.

FIG. 3 is illustrative in schematic section of another example of the holographic viewing card according to the present invention.

FIG. 4 is illustrative in schematic section of yet another example of the holographic viewing card according to the present invention.

FIG. 5 is illustrative in schematic of the function of a Fourier transform lens.

FIG. 6 is illustrative in schematic section of a further example of the holographic viewing card according to the present invention.

FIG. 7(a) is a flowchart illustrative of one transmission hologram fabrication process, and FIG. 7(b) is a schematic view illustrative of that flowchart.

FIG. 8 is illustrative in schematic of what relations an input image has to the pixels of a unit computer-generated hologram.

FIG. 9, schematically illustrates that when another holographic viewing device of the present invention is viewed through a human eye, in what relations the pupil of the eye is to the unit computer-generated holograms of a computer-generated hologram that forms a part of the holographic viewing device.

FIGS. 10(a) and 10(b) are to determine conditions concerning the size of an image reconstructed from a character string image recorded as an input image in a computer-generated hologram, under which conditions individual characters are visually perceivable in the reconstructed image.

FIG. 11 is illustrative of one example of a character string recorded as an input image in a computer- generated hologram.

FIGS. 12(a), 12(b) and 12(c) are illustrative of prior art holographic spectacles and how they work.

### DESCRIPTION OF THE PREFERRED EMBODIMENTS

As will be described below in details, the holographic viewing device of the present invention is characterized in that a printing layer is provided on a transmission hologram. By providing the printing layer on the transparent hologram, it is possible to decorate the transparent hologram, and to dispense with the frame required so far to fit the transparent hologram in place, so that not only can the cost of the frame be saved but also the processing cost for integration of the frame and the transparent hologram can be cut down. It is thus possible to provide a holographic viewing device of simplified construction at low costs.

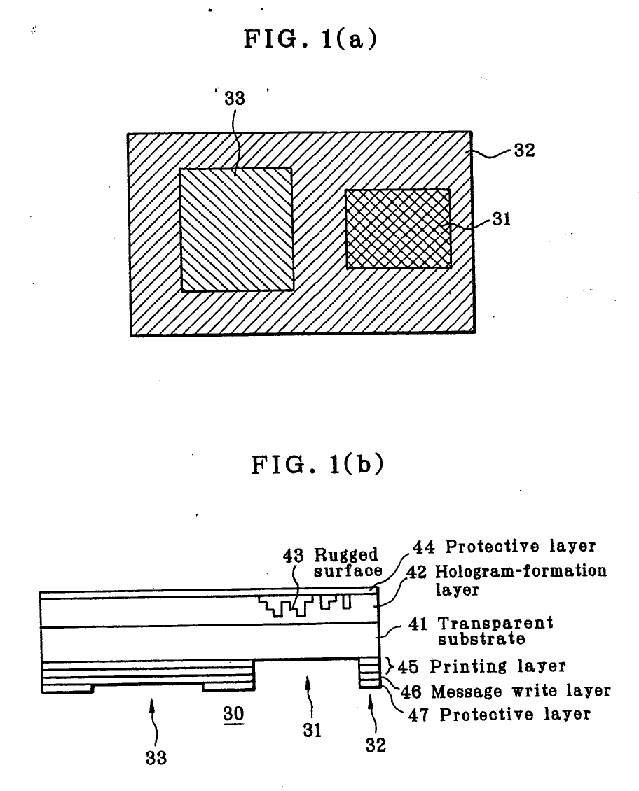

The holographic viewing device of the invention and the holographic viewing card that incorporates it are now explained with reference to the embodiments and examples illustrated in the accompanying drawings. FIG. 1 is a plan view (a) and a sectional view (b) illustrative of one example of the card that comprises the holographic viewing device according to the invention.

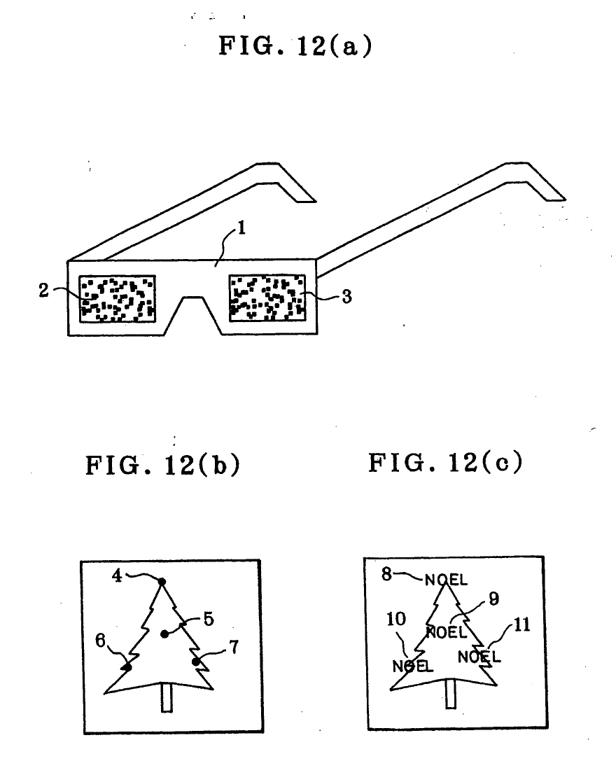

As depicted in the plane view of FIG. 1(a), a card 30 comprising this holographic viewing device is provided. with a transparent hologram area 31, a printing area 32 provided around it and a message write area 33. In the transparent hologram area 31, there is a hologram located, as in patent publication 1, wherein the hologram is a computer-generated hologram constructed as a transmission Fourier transform hologram, and upon viewing point light sources through that transmission hologram, a given image or message can be viewed near the positions of the point light sources (FIG. 12). A given pattern or texture information is printed on the printing area 32, and any desired message may be written on the message write area 33 without restriction, for instance, using a white, oil-based pen.

More specifically, as shown in the sectional view of FIG. 1(b), a hologram-formation layer 42 comprising an ultraviolet curable resin or the like is laminated on one surface of a, transparent substrate 41 that forms the substrate of the card 30, and the surface of the transparent hologram area 31 of the hologram-formation layer 42 is provided with a rugged surface 43 that forms the diffractive surface of such a transmission Fourier transform hologram as described above. To protect the rugged surface 43 of the hologram-formation layer 42, a transparent protective layer 44 is applied to the outer periphery of the transparent hologram area 31 in such a way as to surround the hologram-formation layer 42.

A printing layer 45 and a message write layer 46 are provided on an area of the other surface of the transparent substrate 41 on which the transparent hologram area 31 is not found. A given pattern or textual information is printed on the printing layer 45 of the printing area 32, and the message write layer 46 of the message write area 33 is formed of, for instance, a white layer on which a message or the like may be written by means of an oil-based pen or the like. A protective layer 47 is laminated on an area portion of the printing layer 45 and message write layer 46 other than the message write area 33. Note here that if the message write layer 46 is formed of a printing ink containing, for instance, a white pigment and provided with the surrounding protective layer 47, it is then possible to write the message or the like on the message write area 33 only.

The holographic viewing device of the invention and the holographic viewing card that incorporates it are each constructed as recited above, so that direct printing can be applied to the transparent substrate of the transmission hologram without recourse to any frame for supporting and reinforcing the transmission hologram, and the message write area can be provided, thereby simplifying construction while enhancing aesthetic and decorative attributes.

For the transmission hologram located at the transparent hologram area 31, it is preferable to use a phase hologram wherein a hologram diffraction pattern is recorded by a difference in the depth of the rugged pattern on the film surface but, of course, use may be made of a transmission hologram working as a phase type diffractive optical element that is also of the refractive index modulation type and has a refractive index profile in its layer, or a transmission hologram working as an amplitude type diffractive optical element wherein a hologram pattern is recorded by a transmitting portion and a non-transmitting portion.

When the transmission hologram is provided in the form of a phase hologram having a rugged surface 43 on its surface, the rugged pattern on the film surface may be configured by use of a thermoplastic resin, a thermo-setting resin, and an ultraviolet curable resin.

Preferably, the printing layer 45 on the transmission hologram is provided at a surface that faces away from the rugged surface 43 that forms the hologram diffraction pattern. This is because as the printing layer 45 is printed on the rugged surface, it causes the rugged pattern to be leveled out, resulting in loss of its hologram reconstruction function, and because the rugged surface is generally hard to receive a printing layer often thanks to high water repellency.

Preferably, the rugged surface 43 of the transmission hologram is located at a side facing away from the viewing side often in touch with the user's hands. Otherwise, the risk of the rugged pattern being leveled out by grime, resulting in loss of its hologram reconstruction function, will grow higher.

Preferably, the rugged surface 43 is provided with the protective layer 44. Otherwise, the rugged surface 43 will be leveled out by grime, resulting in loss of its hologram reconstruction function.

As depicted in FIG. 1, there may be the message write layer 46 located on the printing layer 45, on which a message may be written by means of an oil-based pen, a ball-pointed pen, a pencil or the like.

Preferably, the message write layer 46 is provided thereon with the protective layer 47 for protection of a portion that is spared.

Note here that the printing layer 45 may be made up of two printing layers capable of displaying separate pieces of information on both sides via a shielding layer.

If this is done, it is then possible to view display information different from display information viewed on the viewing side (that faces away from the rugged surface 43 side) through the transparent substrate 41 and the hologram-formation layer 42.

The requirements for the transparent substrate 41, the hologram-formation layer 42, the printing layer 45, the message write layer 46 and the protective layer 47 are now explained.

The transparent substrate 41 is a substrate material for the hologram-formation layer 42, and to this end, polycarbonate, PET, etc. may be used, although they must be transparent to visible light. Thickness may be chosen from the range of about 0.1 mm to about 10 mm, as desired.

To make the holographic viewing device of the invention easy-to-carry and easy-to-view, it is preferable to use a planar member having nerve as the transparent substrate 41. Another requirement is that the rugged surface 43 (diffractive surface) can be provided on one surface while the printing layer 45 can be formed on the other or opposite side.

The hologram-formation layer 42 is a hologram layer that enables a given image or message to be viewed near the positions of point light sources upon viewing them. Typically, a layer having the rugged surface 43 on its surface is used to this end. In some cases, however, use may be made of a layer (for instance, photopolymer) having a refractive index profile of refractive index modulation inside or a layer having a transmittance profile. For the layer having a rugged surface, use may be made of a thermoplastic resin, a thermosetting resin, an ultraviolet curable resin, an electron beam curable resin, or the like. Note here that the concave surface 43 is preferably recessed from the surrounding plane, because of ease of location of the protective layer 44.

The printing layer 45 is provided to enhance the aesthetic attribute of the holographic viewing device of the invention. By providing a different printing layer 45 on the common hologram-formation layer 42, one can have a plenty of design variations for the holographic viewing device. By provision of a plurality of printing layers 45, one can have different designs for the front and back surfaces of the holographic viewing device.

The message write layer 46 is a layer through which an oil-based pen, a ball-pointed pen, a pencil or the like may be used to write a message or pattern on the holographic viewing device of the invention, as desired. This allows the holographic viewing device of the invention to be used as a message card. The printing layer 45 may also serve as the message write layer 46. It is not always necessary to cover the whole surface of the printing area 32 with the printing layer 45; a part of the printing layer 45 is eliminated to use a transparent pattern as a part of design.

The protective layer 47 is provided to protect the printing layer 45. If a portion 33 of the message write layer 46 on which a message is to be written is bared out and the protecting layer 47 is applied to the rest, the robustness of the holographic viewing device of the invention can then be improved.

Some embodiments and examples of the holographic viewing card of the invention, which is applicable to cards such as business cards and membership cards, toys or the like, can be printed on demand, and has a hologram viewing section are now explained.

The holographic viewing card according to the invention includes two embodiments, which are now separately explained.

A. First Embodiment

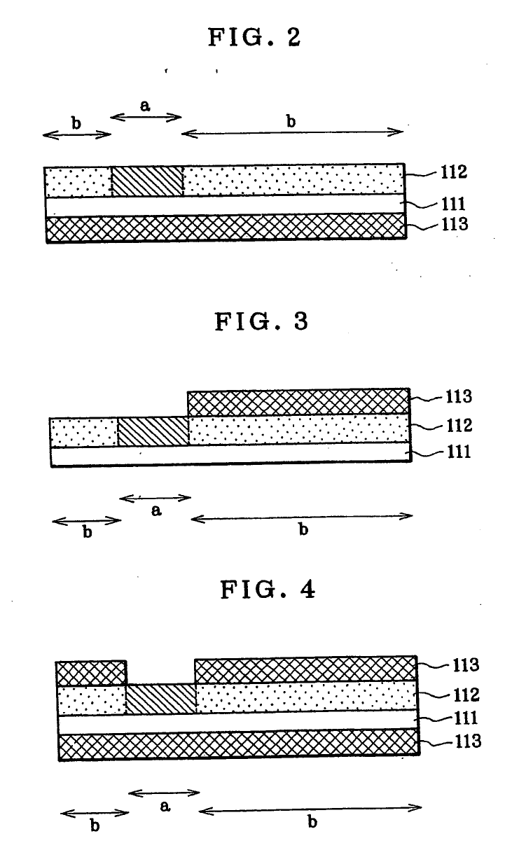

First, the first embodiment of the holographic viewing card of the invention is explained. The holographic viewing card here comprises a transparent substrate, and an image transform layer formed on said transparent substrate and comprising a transmission Fourier transform hologram area (having a Fourier transform lens function) that enables a given image or message to be viewed near the positions of point light sources upon viewing the point light sources through a hologram and a non-hologram area that is not included in said transmission Fourier transform hologram area and has not the Fourier transform lens function, characterized in that a printable receptor layer is formed on the side of said transparent substrate that faces away from said image transform layer or on said non-hologram area of said image transform layer. As shown typically in FIG. 2, the hologram viewing sheet according to this embodiment comprises a transparent substrate 111, an image transform layer 112 formed on that transparent substrate 111 and comprising a transmission Fourier transform hologram area a and a non-hologram area b, and a receptor layer 113 formed on the side of said transparent substrate 111 that faces away from the image transform layer 112. Alternatively, as shown typically in FIG. 3, the hologram viewing sheet comprises a transparent substrate 111, an image transform layer 112 formed on that transparent substrate 111 and comprising a transmission Fourier transform hologram area a and a non-hologram area b, and a receptor layer 113 formed on the non-hologram area b of said image transform layer 112.

In this embodiment, as shown typically in FIG. 4, the receptor layer 113 may be formed on two surfaces: the surface of the transparent substrate 111 that faces away from the image transform layer 112 and the surface of the non-hologram area b of the image transform layer 112.

According to the first embodiment of the invention wherein the printable receptor layer is provided, it is possible for the user to print various images such as individual information on the receptor layer. In this case, the receptor layer is formed on the surface of the transparent substrate that faces away from the image transform layer or the non-hologram area of the image transform layer, so that an image or the like printed on the receptor layer does not offer an obstacle to the formation of a light image on the transmission Fourier transform hologram area.

Another advantage of the first embodiment of the invention wherein the transmission Fourier transform hologram area is formed in the image transform layer is that the holographic viewing card can efficiently be fabricated without providing or interleaveing another member (having a transmission Fourier transform lens) that enables a given image or message to be viewed near the positions of point light sources upon viewing the point light sources through the hologram.

The holographic viewing card according to the first embodiment of the invention is now explained at great length for each component.

1. Receptor Layer

First, the receptor used herein is now explained. The receptor layer used herein is a printable layer that is formed on the surface of the transparent substrate (to be described later) that faces away from the image transform layer or the non-hologram area of the image transform layer, which has no Fourier transform lens function.

In the embodiment here, the receptor layer may be formed all over the surface of the transparent substrate or the non-hologram area or, alternatively, it may be formed on only a part of the transparent substrate or the non-hologram area. The shape and extent of the area on which the receptor layer is to be formed may be optionally selected depending on the type of the holographic viewing card, applications where it is used, or the like.

For the receptor layer, it is only needed to be printable by common methods, and no particular limitations are imposed on printing modes or the like. In the present embodiment, it is particularly preferred that the holographic viewing card is printable on demand, especially in a sublimation heat transfer mode, an ink jet mode, a thermal transfer mode, and an intermediate transfer mode. The printable receptor layer is now separately explained with reference to these printing modes.

### Receptor Layer Printable in the Sublimation Heat Transfer Mode

For the receptor layer printable in the sublimation heat transfer mode, there is no particular requirement but to be capable of receiving sublimation heat transfer inks. Such a receptor layer may be formed of a layer that contains one or more resins selected from a resin having an ester bond such as a polyester resin, a polyacrylic acid ester resin, a polycarbonate resin, a polyvinyl acetate resin, a styrene acrylate resin and a vinyl toluene acrylate resin; a resin having an urethane bond such as a polyurethane resin; a resin having an amide bond such as a polyamide resin (nylon); a resin having an urea bond such as a polyurethane resin; and a resin having a bond of high polarity such as a polycaprolactone resin, a polystyrene resin, a polyvinyl chloride resin and a polyacrylonitrile resin. A layer comprising a mixed resin of saturated polyester and vinyl chloride-vinyl acetate copolymers may also be used. The saturated polyester used herein, for instance, includes Bylon 200, Bylon 290 and Bylon 600 (all made by Toyobo Co., Ltd.), KA-10380 (made by Arakawa Chemical Co., Ltd.), TP220 and TP235 (both made by Nippon Synthesis Chemistry Industries Co., Ltd.). For the vinyl chloride-vinyl acetate copolymers, those having a vinyl chloride component content of 85 to 98 wt % and a polymerization degree of about 200 to about 800 are preferably used. The vinyl chloride-vinyl acetate copolymers here may also contain a vinyl alcohol component, a maleic acid component and so on.

The receptor layer may also be formed of a layer containing, for instance, a polystyrene resin. For instance, use may be made of a layer containing a polystyrene resin comprising homo- or co-polymers of styrene monomers such as styrene, α-methylstyrene, and vinyl toluene, or a styrene copolymer resin of a styrene monomer and other monomer, for instance, an acrylic or methacrylic monomer such as an acrylic acid ester, a methacrylic acid ester, and a methacrylonitrile or maleic anhydride.

The receptor layer printable in the sublimation heat transfer mode, for instance, may be formed by coating or printing a mixture of the above resin optionally with an additive such as an ultraviolet absorber, a solvent, etc. on the transparent substrate or the image transform layer by known techniques. Note here that the receptor layer has preferably a thickness of about 0.5 μm to about 50 μm, especially about 1 μm to about 20 μm.

### Receptor Layer Printable in the Ink Jet Mode

For the receptor layer printable in the ink jet mode, there is no particular requirement but to receive well ink-jet inks, and such a receptor layer may be formed of a porous layer or the like that, for instance, comprises an alumina hydrate. In the alumina hydrate porous layer, the alumina hydrate is preferably bound with a binder. For the alumina hydrate, what is called boehmite (Al₂O₃.nH₂O where n=1 to 1.5) is preferably used, because it is well absorbable and well selectively adsorbs a dye, yielding a clear image having a high color concentration.

The alumina hydrate porous layer has preferably a microstructure substantially comprising micropores having a radius of 1 to 15 nm and a volume of 0.3 to 1.0 cc/g, because of being capable of absorbing a plenty of ink-jet ink, and transparent as well. More preferably, the alumina hydrate porous layer has an average micropore radius of 3 to 7 nm.

The binder used with the alumina hydrate porous layer, for instance, include organic materials such as starch or its modifications, polyvinyl alcohol or its modifications, SBR (butadiene-styrene rubber) latex, NBR (butadiene-acrylonitrile rubber) latex, hydroxycellulose, and polyvinyl pyrrolidone. The amount of the binder used herein is preferably about 5 to 50 mass% of the alumina hydrate, because too much can possibly cause the strength of the alumina hydrate porous layer to become insufficient, whereas too little can possibly cause the amount of the ink absorbed or the amount of the dye carried to become low.

Another receptor layer printable in the ink jet mode is a layer containing amorphous fine silica. The amorphous fine silica is silica obtained by wet- or dry-precipitation, known as white carbon, silicic acid anhydride, hydrous silicic acid or the like. The amorphous fine silica has preferably an average particle diameter of 0.5 to 15 μm, because of ensuring high oil absorptions. In addition to the amorphous silica, if required, the amorphous fine silica-containing receptor layer may also contain other pigments, for instance, those commonly used for coated paper such as zeolite, calcium carbonate, diatomaceous earth, kaolin, fired clay, talc and aluminum hydroxide. The amount of such pigments to be added is preferably 30 to 80 mass % of the solid matter of the receptor layer. Greater than 80 mass % may possibly cause the strength of the receptor layer to become low, rendering printing impossible for reasons of flaws or scratches.

The binder resin used for the amorphous fine silica-containing receptor layer, for instance, includes polymers, e.g., polyvinyl alcohol or its modifications, proteins such as casein, starch or its modifications, latexes such as styrene-butadiene copolymers and methyl methacrylate-butadiene copolymers, polymer or copolymer latexes of acrylic acid esters and methacrylic acid esters, and polymers such as polyvinyl butyral resins, unsaturated polyester resins, and alkyd resins. The use of these resins ensures improvements in the adhesion between the binder resin and the pigment. The proportion of the binder used in the receptor layer is 20 to 70 mass %, preferably 25 to 60 mass % of the solid matter of the receptor layer. At less than 20 mass %, adhesion force would become insufficient, often resulting in a decrease in the strength of the receptor layer and inducing defects in the recording layer for reason of flaws or scratches. At greater than 70 mass %, the proportion of the ink to be used would become low, often resulting in a problem with ink absorption, although there is an increased adhesion.

The receptor layer printable in the ink jet mode, for instance, may be formed by coating or printing a mixture of the above material optionally with an additive such as an ultraviolet absorber, a solvent, etc. on the transparent substrate or the image transform layer by known techniques. Note here that this receptor layer has preferably a thickness of about 1 μm to about 50 μm, especially about 10 μm to about 40 μm.

### Receptor Layer Printable in the Thermal Transfer Mode

For the receptor layer printable in the thermal transfer mode, there is no particular requirement but to be capable of receiving a thermally molten ink. Such a receptor layer, for instance, may be formed of a layer comprising a thermoplastic resin. The resin that can form that receptor layer, for instance, include various polyester resins, vinyl chloride-vinyl acetate copolymer resins, polycarbonate resins, polyurethane resins, polyether resins, polyamide resins, acrylic resins, and cellulose derivatives. Preferably, that receptor layer optionally contains a crosslinking agent, a lubricant, a release agent and so on. With the addition of these, when an ink ribbon is heated by a thermal head for printing on the receptor layer, possible fusion of the ink ribbon and the receptor layer can be prevented. If required, that receptor layer may also contain an antioxidant, a pigment, an ultraviolet absorber or other additives. Such various additives may have been mixed with the above resin before the formation of the receptor layer, or a coating layer comprising various additives may be formed on the receptor layer.

The receptor layer printable in the thermal transfer mode, for instance, may be formed by coating or printing a mixture of the above resin optionally with additives, a solvent, etc. on the transparent substrate or the image transform layer by known techniques. Note here that this receptor layer has preferably a thickness of about 0.5 μm to about 50 μm, especially about 1 μm to about 20 μm.

### Receptor Layer Printable in the Intermediate Transfer Mode

For the receptor layer printable in the intermediate transfer mode, there is no particular requirement but to be capable of receiving an ink transferred in the intermediate transfer mode. That receptor layer, for instance, may be the same as that printable in the above thermal transfer mode. In this case, too, that receptor layer has preferably a thickness of about 0.5 μm to about 50 μm, especially about 1 μm to about 20 μm.

2. Image Transform Layer

The image transfer layer used in the present embodiment of the invention is now explained. The image transform layer here is formed on the transparent substrate to be describe later, and comprises a transmission Fourier transform hologram area (having a Fourier transform lens function) that enables a given image or message to be viewed near the positions of point light sources upon,viewing them through a hologram and a non-hologram area that is located other than the above transmission Fourier transform hologram area and has no Fourier transform lens function. The shape, extent, etc. of the above transmission Fourier transform hologram area may be optionally chosen depending on the type of the holographic viewing card, applications where it is used, etc.

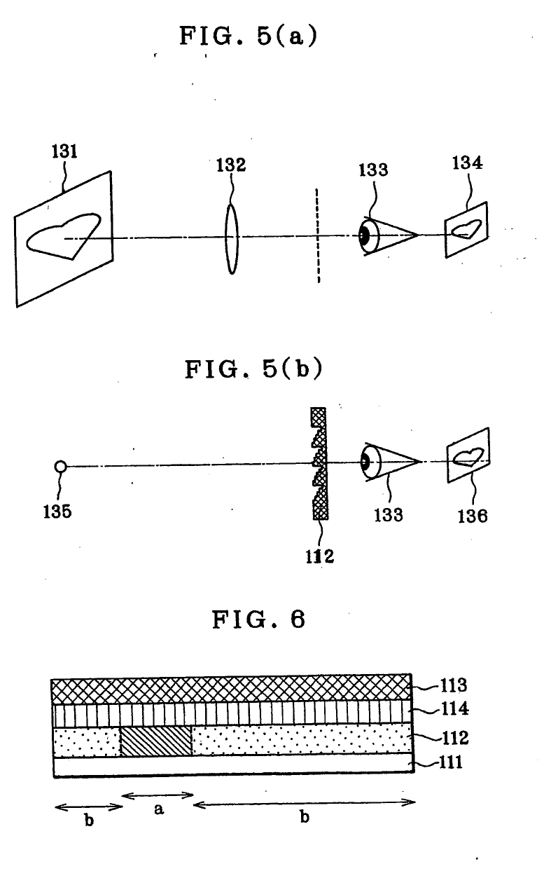

Here, the Fourier transform lens function of the above transmission Fourier transform hologram area is explained with reference to FIG. 5. FIG. 5(a) is illustrative in schematic of where an image is viewed through an ordinary lens, and FIG. 5(b) is illustrative in schematic of where an image is viewed through the Fourier transform lens function of the transmission Fourier transform hologram area of the image transform layer in the present embodiment. With the desired image 131 viewed with a human eye 133 through a lens 132 as depicted in FIG. 5(a), an image 134 similar in form to the image 131 is visible.

On the other hand, with a point light source 135 viewed with the human eye 133 through the transmission Fourier transform hologram area of an image transform layer 112 as depicted in FIG. 5(b), there is an optical image 136 visible, which matches with data recorded in the transmission,Fourier transform hologram area of the image transform layer 112. For instance, if a rugged shape capable of reconstructing such a heart image as depicted in FIG. 5(b) is positioned at the transmission Fourier transform hologram area of the image transform layer 112, a heart light image 136 is then visible by viewing the point light source 135 through the image transform layer 112. Thus, the “Fourier transform lens function” that the image transform layer here has is understood to mean the function of transforming the light incident from the point light source into the desired light image (see patent publication 1).

In the present embodiment, there is no particular limitation on the wavelength of the point light source at which the transmission Fourier transform hologram area of the image transform layer can function as a Fourier transform lens; any desired wavelength may be used. The wavelength of the point light source may include just only monochromatic light of a single wavelength but also light of multi-wavelengths and even white light.

For the image transform layer here, there is no critical requirement but to have a transmission Fourier transform hologram area possessing a Fourier transform lens function. For instance, use may be made of a surface phase type diffractive optical element layer having a relief structure on the surface of the above transmission Fourier transform hologram area or an internal phase type diffractive optical element layer having a refractive index profile in the image transform layer of the above transmission Fourier transform hologram area. Use may also be made of an amplitude type diffractive optical element layer having a transmittance profile at the above transmission Fourier transform hologram area. These optical element layers are now separately explained.

### Surface Phase Type Diffractive Optical Element Layer

When the above image transform layer is the surface phase type diffractive optical element layer, a rugged pattern is as a matter of fact formed on the surface of the above transmission Fourier transform hologram area of the image transform layer. That image transform layer may be either transparent or have been colored.

Such an image transform layer, for instance, may be formed by the following technique By computation, the data for the image to be displayed by the transmission Fourier transform hologram area is first converted into Fourier transform data, which are then two-valued, four-valued or the like. Subsequently, the data are converted into rectangular data for electron-beam lithography. Then, such rectangular data are loaded in an electron-beam lithographic system used for semiconductor circuit mask lithography to write them to a resist surface coated on a glass plate or the like, thereby preparing an original plate. Note here that the portion to define the above non-hologram area is provided in a flat plate form.

Thereafter, for instance, a 2P technique (Photo-Polymerization technique), an injection molding technique, a sol-gel technique, a hard embossing technique, a soft embossing technique, semidry embossing technique or various nano-imprinting techniques are used to form a layer with the rugged pattern of that original plate copied in it, thereby forming the image transform layer. In the present embodiment, the 2P technique is preferably used, because the image transform layer can be formed with efficiency.

When the image transform layer is formed by that 2P technique, for instance, an ionizing radiation curing resin composition is added as droplets to the above original plate, and the transparent substrate is placed down on that ionizing radiation curing resin composition. Then, the stack is irradiated with ionizable radiation such as ultraviolet from the original plate side or the transparent substrate side to cure the ionizing radiation curing resin composition, after which the ionizing radiation cured resin composition and the transparent substrate are peeled off the original plate.

Here, by way of example but not by way of limitation, various resin materials such as thermosetting, thermoplastic and ionizing radiation curing resins used so far as relief hologram formation layer materials are all usable for the formation of the above image transform layer.

The thermosetting resin here, for instance, includes unsaturated polyester resins, acrylic-modified urethane resins, epoxy-modified acrylic resins, epoxy-modified unsaturated polyester resins, alkyd resins, and phenol resins, and the thermoplastic resin here, for instance, includes acrylic acid ester resins, acrylamide resins, nitrocellulose resins, and polystyrene resins.

These resins may be either a homopolymer or a copolymer comprising two or more.components, and used alone or in combination of two or more as well. They may also contain various isocyanate compounds, metal soaps such as cobalt naphthenate and zinc naphthenate, organic peroxides such as benzoyl peroxide and methyl ethyl ketone peroxide, and thermosetting or radiation curing agents such as benzophenone, acetophenone, anthraquinone, naphtoquinone, azobisisobutyronitrile and diphenyl sulfide in a selective, optional manner.

The above ionizing radiation curing resin, for instance, includes epoxy-modified acrylate resins, urethane-modified acrylate resin, and acrylic-modified polyesters, among which the urethane-modified acrylate resins are preferable, and most preference is given to the urethane-modified acrylic resins represented by the following formula.

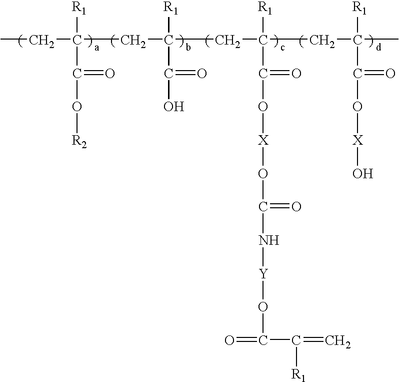

In the ‘above’ formula, five R₁'s are each independently indicative of a hydrogen atom or a methyl group, R₂ is indicative of a C₁ to C₁₆ hydrocarbon group, X and Y are each indicative of a straight- or branched-chain alkylene group, and when (a+b+c+d) is supposed to be 100, a is an integer of 20 to 90, b is an integer of 0 to 50, c is an integer of 10 to 80 and d is an integer of 0 to 20.

One preferable example of the urethane-modified acrylic resin represented by the above formula is obtained by the reaction of a methacryloyloxyethyl isocyanate (2-isocyanate ethyl methacrylate) with hydroxyl groups found in a acrylic copolymer obtained by the copolymerization of 20 to 90 moles of methyl methacrylate and 10 to 80 moles of 2-hydroxyethyl methacrylate. Accordingly, that methacryloyloxyethyl isocyanate has not necessarily reacted with all hydroxyl groups present in the copolymer; namely, at least 10 mol % or more, preferably 50 mol % or more of the hydroxyl groups in the 2-hydroxyethyl methacrylate unit in the copolymer may have reacted with the methacryloyloxyethyl isocyanate. Instead of or in addition to that 2-hydroxethyl methacrylate, monomers having hydroxyl groups such as N-methylolacrylamide, N-methylolmethacrylamide, 2-hydroxyethyl acrylate, 2-hydroxyethyl methacrylate, 2-hydroxypropyl acrylate, 2-hydroxypropyl methacrylate, 4-hydroxybutyl acrylate and 4-hydroxybutyl methacrylate may be used, too.

When it comes to the urethane-modified acrylic resin represented by the above formula, the above copolymer is dissolved in a solvent in which it is dissolvable, for instance, toluene, ketone, cellosolve acetate and dimethylsulfoxide. While the resulting solution is agitated, the methacryloyloxyethyl isocyanate is added as droplets to the solution for reaction to the copolymer, so that isocyanate groups react with hydroxyl groups in the acrylic resin to yield urethane bonds, through which methacryloyl groups are introduced in the resin. The methacryloyloxyethyl isocyanate is used in such an amount as to provide 0.1 to 5 moles, preferably 0.5 to 3 moles per mole of hydroxyl groups in the acrylic resin. It is noted that when the methacryloyloxyethyl isocyanate is used in an amount greater than the equivalent weight of the hydroxyl groups in the above resin, —CONH—CH₂CH₂— linkages may possibly be formed via the reaction of the methacryloyloxyethyl isocyanate with carboxyl groups in the resin, too.

The foregoing example is the case wherein, in the above formula, all R₁ and R₂ are methyl groups, and X and Y are ethylene groups. The present embodiment is not limited to that case; five R₁'s may be each independently a hydrogen atom or a methyl group. Further, R₂ may be a methyl group, an ethyl group, an n- or iso-propyl group, an iso- or tert-butyl group, a substituted or unsubstituted phenyl group, and a substituted or unsubstituted benzyl group, and X and Y may be an ethylene group, a propylene group, a diethylene group, and a dipropylene group. The total molecular weight of the thus obtained urethane-modified acrylic resin is preferably 10,000 to 200,000, especially 20,000 to 40,000 on the basis of a standard polystyrene base weight-average molecular weight as measured by GPC.

When the above ionizing radiation curing resin is cured, such mono- or poly-functional monomers and oligomers as mentioned below may be used together with the above monomer for the purpose of regulating cross-linked structure, viscosity, and so on.

The above mono-functional monomers, for instance, include mono(meth)acrylates such as tetrahydrofulfuryl (meth)acrylate, hydroxyethyl (meth)acrylate, vinyl pyrrolidone, (meth)acryloyloxyethyl succinate and (meth)acryloyloxyethyl phthalate, and the di- or poly-functional monomers include, in terms of classification by skeleton structure, polyol (meth)acrylates (for instance, epoxy-modified polyol (meth)acrylates and lactone-modified polyol (meth)acrylates), polyester (meth)acrylates, epoxy (meth)acrylates and urethane (meth)acrylates as well as poly(meth)acrylates based on polybutadiene, isocyanuric acid, hydantoin, melamine, phosphoric acid, imide and phosphazine. Thus, a variety of monomers, oligomers and polymers capable of being cured by ultraviolet, and ionizing radiation may be used.

To be more specific, the bifunctional monomers and oligomers, for instance, polyethylene glycol di(meth)acrylates, polypropylene glycol di(meth)acrylates, neopentyl glycol di,(meth)acrylates and 1,6-hexanediol di(metha)acrylates, and the trifunctional monomers, oligomers and polymers, for instance, include trimethylolpropane tri(meth)acrylates, pentaerythritol tri(meth)acrylates, ditrimetylolpropane tetra (meth)acrylates and aliphatic tetra(meth)acrylates. Tetra-functional monomers and oligomers, for instance, include pentaerythritol tetra(meth)acrylates, ditrimethylolpropane tetra(meth)acrylates and aliphatic tetra(meth)acrylates, and penta- or poly-functional monomers and oligomers, for instance, include dipentaerythritol penta(meth)acrylates and dipentaerythridol hexa(meth)acrylates as well as (meth)acrylates having a polyester skeleton, an urethane skeleton, and a phosphazine skeleton. While there is no critical limitation on the number of functional groups, it is understood that as the number of functional groups is less than 3, it causes heat resistance to become low, and as the number of functional groups is greater than 20, it causes flexibility to become low; the number of functional groups is most preferably 3 to 20.

While the amount of those mono- and poly-functional monomers and oligomers to be used may be determined as desired depending on how to fabricate the image transform layer or the like, it is understood that they are preferably used in an amount of ordinarily less than 50 parts by weight, especially 0.5 to 20 parts by weight per 100 parts by weight of the ionizing radiation curing resin.

If required, the image transform layer here may optionally contain additives such as photo-polymerization initiators, polymerization inhibitors, degradation preventives, plasticizers, lubricants, coloring agents such as dyes and pigments, fillers adapted to prevent extension and blocking, for instance, extender pigments and resins, surface active agents, defoamers, leveling agents and tixotropic agents.

### Internal Phase Type Diffractive Optical Element Layer

When the above image transform layer is an internal phase type diffractive optical element layer, the interference fringes of object light and reference light are recorded in the above transmission Fourier transform hologram area of the image transform layer, so that a light image can be viewed by reason of a refractive index difference between the components forming the interference fringes and the components forming inter-fringe portions.

For the material that forms such an image transform layer, photosensitive compositions may be used. Generally, known photosensitive materials such as silver halide materials, bichromated gelatin emulsifiers, photo-polymerizable resins and photo-crosslinkable resins are used. In view of fabrication efficiency, the photosensitive compositions that contain the following materials (i) and (ii) are most preferably used herein.

Such photosensitive materials are now explained.

(i) Photosensitive Composition Containing a Binder Resin, a Photo-polymerizable Compound, a Photo-polymerization Initiator and a Sensitizing Dye

First of all, the photosensitive composition containing a binder resin, a photo-polymerizable compound, a photo-polymerization initiator and a sensitizing dye is explained. The binder resin here, for instance, includes a poly(meth)acrylic acid ester or its partial hydrolysate, polyvinyl acetate or its partial hydrolysate, copolymers having as a polymerizing component at least one chosen out of a group of monomers such as acrylic acid and acrylic acid ester or their mixtures, polyisoprene, polybutadiene, polycholoroprene, polyvinyl acetal that is a partially acetallized product of polyvinyl alcohol, polyvinyl butryal, polyvinyl acetate, and vinyl chloride-vinyl acetate copolymers or their mixtures. When the image transform layer is formed, there is a step of migration by heating of the monomers provided to stabilize the hologram recorded in the above transmission Fourier hologram area. Preferably to this end, the binder resin has a relatively low glass transition temperature, and is capable of bringing on ready migration of the monomers.

For the photo-polymerizable compound contained in the photosensitive composition, monomers, oligomers and prepolymers having at least one ethylenic unsaturated bond per molecule and capable of photo-polymerization and photo-crosslinking, as described later, or their mixtures may be used. For instance, unsaturated carboxylic acids or their salts, esters of unsaturated carboxylic acids and aliphatic polyvalent alcohols, and amide compounds of unsaturated carboxylic acids and aliphatic polyvalent amine compounds are mentioned.

Exemplary unsaturated carboxylic acid monomers are acrylic acid, mathacrylic acid, itaconic acid, crotonic acid, isocrotonic acid, and maleic acid. The ester monomers of aliphatic polyvalent alcohol compounds and unsaturated carboxylic acids may include those classified as acrylic acid esters, for instance, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropy) ether, and trimethylolethane triacrylate.

Among those classified as methacrylic acid esters, for instance, there are tetramethylene glycol dimethacrylate, triethylene glycol dimethacrylate, neopentyl glycol dimethacrylate, trimethylolpropane trimethacrylate and trimethylolethane trimethacrylate. Among those classified as itaconic acid esters, for instance, there are ethylene glycol diitaconate, propylene glycol diitaconate and 1,3-butanediol diitaconate. Among those classified as crotonic acid esters, for instance, there are ethylene glycol dicrotonate, tetramethylene glycol dicrotonate, pentaerythritol dicrotonate and sorbitol tetracrotonate. Among those classified as isocrotonic acid esters, for instance, there are ethylene glycol diisocrotonate, pentaerythritol diisocrotonate and sorbitol tetraisoc;otonate. Among those classified as maleic acid esters, for instance, there are ethylene glycol dimaleate, pentaerythritol dimaleate and sorbitol tetramaleate.

Among those classified as halogenated unsaturated carboxylic acids, for instance, there are 2,2,3,3-tetrafluoropropyl acrylate, 1H,1H,2H,2H-heptadecafluoro-decyl acrylate and 2,2,3,3-tetrafluoropropyl methacrylate. The amide monomers of unsaturated carboxylic acids and aliphatic polyvalent amine compounds, for instance, include methylenebisacrylamide, methylenebismethacrylamide, 1,6-hexamethylenebisacrylamide and 1,6-hexamethylenebis-methacrylamide.

Among the photo-polymerization initiator used herein, for instance, there are 1,3-di(t-butyldioxycarbonyl) benzophenone; 3,3′,4,4′-tetrakis(t-butyldioxycarbonyl) benzophenone, N-phenylglycine, 2,4,6-tirs(trichloro-methyl)-s-triazine, 3-phenyl-5-isooxazolone, 2-mercaptobenzimidazole, and imidazole dimmers. In view of the stabilization of the recorded hologram, the photo-polymerization initiator should preferably be removed by decomposition after hologram recording. For instance, organic peroxide initiators are preferred because of being easy to decompose by ultraviolet irradiation.

Among the sensitizing dyes having absorption light at 350 to 600 nm, for instance, there are thiopyrylium salt dyes, merocyanine dyes, quinoline dyes, styryl-qinoline dyes, ketocoumarin dyes, thioxanthene dyes, xanthene dyes, oxonol dyes, cyanine dyes, rhodamine dyes, pyrylium ion dyes, and diphenylidonium ion dyes. It is also acceptable to use sensitizing dyes having absorption light at a wavelength of less than 350 nm or greater than 600 nm.

The photosensitive composition comprising the binder resin, the photo-polymerizable compound, the photo-polymerization initiator and the sensitizing dye is used at the following quantitative proportion. The photo-polymerizable compound is used in an amount of 10 parts by mass to 1,000 parts by mass, preferably 10 parts by mass to 100 parts by mass per 100 parts by mass of binder resin; the photo-polymerization initiator is used in an amount of 1 part by mass to 10 parts by mass, preferably 5 parts by mass to 10 parts by mass per 100 parts by mass of binder resin; and the sensitizing dye is used in an amount of 0.01 part by mass to 1 part by mass, preferably 0.01 part by mass to 0.5 part by mass per 100 parts by mass of binder resin. The rest of the photosensitive composition components, for instance, may be plasticizers, glycerin, diethylene glycol, triethylene glycol and a variety of nonionic, anionic and cationic surface active agents.

For use, the above photosensitive composition is usually dissolved in a solvent such as methyl ethyl ketone, cyclohexanone, xylene, tetrahydrofuran, ethyl cellosolve, methyl cellosolve acetate, ethyl acetate and isopropanol, which may be used alone or in admixture, into a coating solution having a solid content of 10% to 25%. When the above transparent substrate is a single sheet form, the above image transform layer is formed as by bar coating, spin coating or dipping of the above photosensitive composition in a diluted state. If the transparent substrate is a roll or continuous form, the image transform layer is formed as by gravure coating, roll coating, die coating or comma coating of the. above photosensitive composition in a diluted state, followed by drying and/or curing, if required. The thus obtained image transform layer has a thickness of 0.1 μm to 50 μm, preferably 5 μm to 20 μm, if required, with a protective film applied over it. When the protective film is used, a resin film of high transparency and high smoothness, for instance, a polyethylene terephthalate film, a polypropylene film or a polyvinyl chloride film having a thickness of about 10 μm to about 100 μm, may be applied over the image transform layer by means of a rubber roller or the like. For the photosensitive composition, for instance, use may be made of a commercial product “OmniDex 801” or the like, Du Pont.

Interference fringes are recorded in the transmission Fourier transform hologram area of such an image transform layer, using two-beam laser light. The laser light usable herein, for instance, includes 633 nm wavelength light in a helium-neon laser in a visible light quantity range; 514.5 nm, 488 nm, and 457.9 nm wavelength light in an argon laser; 647.1 nm, 568.2 nm, and 520.8 nm wavelength light in a krypton laser; 337.5 nm, 350.7 nm, and 356.4 nm wavelength light in a krypton laser (1.5 W); 351.1 nm, and 368.8 nm wavelength light in an argon laser. (40 mW); 332.4 nm wavelength light in a neon laser (50 mW); and 325.0 nm wavelength light in a cadmium laser (15 mW).

Using one out of these wavelengths that enable the photo-polymerization initiator to be excited, interference fringes are recorded, or interference light of object light and reference light is recorded. Alternatively, after removal of the protective film, a master hologram is brought into contact with the image transform layer, and a laser is entered in the image transform layer from the image transform layer side,. so that interference fringes of light reflected from the input hologram and incident light are recorded to impart hologram information thereto.

Afterwards, the image transform layer is stabilized by steps of decomposing the photo-polymerization initiator by irradiation with ultraviolet rays of 0.1 to 10,000 mJ/cm², preferably 10 to 1,000 mJ/cm² from a suitable light source such as a super high pressure mercury-vapor lamp, a high pressure mercury-vapor lamp, a carbon arc lamp, a xenon arc lamp or a metal halide lamp, and diffusing and migrating the photo-polymerizable compound by heating, e.g., a 24-minute heating at 120° C.

(ii) Photosensitive Composition Containing a Cation-polymerizable Compound, a Cadical-polymerizable Compound, a Photo-radical Polymerization Initiator Systemt that is Sensitive to Specific Wavelength Light to Polymerize the Radical-polymerizable Compound, and a Photo-cation Polymerization initiator system that is of low sensitivity to that Specific Wavelength Light but Sensitive to Another Wavelength Light to Polymerize the Cation-polymerizable Compound

Reference is next made to the photosensitive composition containing a cation-polymerizable compound, a radical-polymerizable compound, a photo-radical polymerization initiator system that is sensitive to specific wavelength light to polymerize the radical-polymerizable compound, and a photo-cation polymerization initiator system that is of low sensitivity to that specific wavelength light but sensitive to another wavelength light to polymerize the cation-polymerizable compound.

This photosensitive material is coated on the transparent substrate, then irradiated with laser light or the like to which the photo-radical polymerization initiator system is sensitive, and finally irradiated with light having a different wavelength from that of the above laser light or the like, to which the photo-cation polymerization initiator system is sensitive, thereby recording a hologram therein. By irradiation with the laser light or the like (hereinafter called the first exposure), the radical-polymerizable compound is polymerized. Thereafter, the cation-polymerizable compound is subjected to overall exposure (hereinafter called the post-exposure), so that it is subjected to cation polymerization by BrΦnsted acid or Lewis acid generated by the decomposition of the photo-cation polymerization initiator system in the composition.

The cation-polymerizable compound used herein should be liquid at room temperature so that its polymerization can take place in a composition of relatively low viscosity all along. Such cation-polymerizable compounds, for instance, include diglycerol diether, pentaerythritol polyglycidyl ether, 1,4-bis(2,3-epoxy-propoxyperfluoro-isopropyl)cyclohexane, sorbitol polyglycidyl ether, 1,6-hexanediol diglycidyl ether, polyethylene glycol diglycidyl ether, and phenyl glycidyl ether.

The radical-polymerizable compound should preferably have at least one ethylenic unsaturated double bond in its molecule. The radical-polymerizable compound should also have an average refractive index that is greater than that of the above cation-polymerizable compound preferably by at least 0.02; lower refractive indices are not preferable because modulation by refractive index becomes insufficient. This is because the hologram yields by a refractive index difference between the radical-polymerizable compound and the cation-polymerizable compound. The radical-polymerizable compound, for instance, includes acrylamide, methacrylamide, styrene, 2-bromostyrene, phenyl acrylate, 2-phenoxylethyl acrylate, 2,3-naphthalene dicarboxylic acid (acryloxyethyl) mono-ester, methylphenoxyethyl acrylate, nonylphenoxyethyl acrylate, and β-acryloxyethylhydrogen phthalate.

The photo-radical polymerization initiator system may be such that active radicals are formed by the first exposure for hologram fabrication, acting to polymerize the radical-polymerizable compound. Alternatively, a sensitizer that is generally a light absorption component could be used in combination with an active radical generator compound or an acid generator compound. For the sensitizer in the photo-radical polymerization initiator system, colored compounds such as dyes are often used to absorb visible laser light; however, cyanine dyes are preferable for colorless transparent holograms, because they are generally susceptible to decomposition by light. More specifically, when they are used in the present embodiment, there is a colorless transparent hologram obtained, because the dye in the hologram is decomposed by the post-exposure here or letting that hologram stand alone under room light or sunlight for a few hours to a few days, and so the hologram has no absorption in the visible range.

Exemplary cyanine dyes are anhydro-3,3′-dicarboxymethyl-9-ethyl-2,2′-thiacarbocyaninebetaine, anhydro-3-carboxymethyl-3′,9′-diethyl-2,2′-thiacarbocyaninebetaine. 3,3′,9-triethyl-2,2′-thiacarbocyanine. iodine salt, 3,9-diethyl-3′-carboxymethyl-2,2′-thiacarbocyanine.iodine salt, 3,3′,9-triethyl-2,2′-(4,5,4′,5′-dibenzo) thiacarbocyanine iodine salt, 2-[3-(3-ethyl-2-benzothiazolidene)-1-propenyl]-6-[2-(3-ethyl-2-benzothiazolidene)ethylideneimino]-3-ethyl-1,3,5-thiadiazolium.iodine salt, 2-[[3-allyl-4-oxo-5-(3-n-propyl-5,6-dimethyl-2-benzothiazolidene)-ethylidene-2-thiazolynidene]methyl]-3-ethyl-4,5-diphenylthiazolinium.iodine salt, 1,1′,3,3,3′,3′-hexamethyl-2,2′-indotricarbocyanine.iodine salt, 3,3′-diethyl-2,2′-thiatricarbocyanine.perchlorate salt, anhydro-1-ethyl-4-methoxy-6 3′-carboxymethyl-5′-chloro-2,2′-quinothiacyanine-betaine, and anydro-5,5′-diphenyl-9-ethyl-3,3′-disulfopropyloxacarbocyaninehydroxide.triethylamine salt. These may be used alone or in combination of two or more.

Exemplary active radical generator compounds that may be used in combination with the cyanine dyes are diaryl iodonium salts or 2,4,6-substituted-1,3,5-triazines. When high sensitivity is in need, the use of diaryl iodonium salts is particularly preferred. Exemplary diaryl iodonium salts include chlorides, bromides, tetrafluoroborates, hexafluoroantimonates, trifluoronmethane sulfonic acid salts and 9,10-dimethoxyanthracene-2-sufonic acid salts of diphenyliodonium, 4,4′-dichlolodiphenyliodonium, 4,4′-dimethoxydiphenyliodonium, 4,4′-ditertiary butyldiphenyliodonium, and 3,3′-dinitrodiphenylidonium. Exemplary 2,4,6-substituted-1,3,5-triazines are 2-methyl-4,6-bis(trichloromethyl)-1,3,5-triazine, 2,4,6-tris(trichloromethyl)-1,3,5-triazine, 2-phenyl-4,6-bis(tricloromethyl)-1,3,5-triazine, 2,4-bis(trichloromethyl)-6-(p-methoxyphenylvinyl)-1,3,5-triazine, and 2-(4′-methoxy-1′-naphtyl)-4,6-bis(trichloromethyl)-1,3,5-triazine.

For the photo-cation polymerization initiator system, it is preferable to use an initiator system such as one that is less sensitive to the first exposure light but is sensitive to the post-exposure light having a wavelength different from that of the first-exposure light to generate Bronsted acid or Lewis acid for the polymerization of the cation-polymerizable compound;

however, particular preference is given to one that keeps the cation-polymerizable compound from polymerization during the first exposure. The photo-cation polymerization initiator system, for instance, includes diaryliodonium salts, triarylsulfonium salts or iron-allene complexes. Preferable diaryliodonium salts, for instance, include tetrafluoroborates, hexafluorophosphates, hexafluoroarsenates and hexafluoroantimonates of the iodonium salts mentioned in conjunction with the photo-radical polymerization initiator system, and preferable triarylsulfonium salts, for instance, include triphenylsulfonium and 4-tertiary-butyltriphenylsulfonium.

If required, the photosensitive composition may contain a binder resin, a thermal polymerization preventive, a silane coupling agent, a plasticizer, a coloring agent and so on. The binder resin is used for the purpose of improving the film formation capability and film thickness consistency of the composition prior to hologram formation, and allowing interference fringes formed by polymerization by irradiation with light like laser light to be stably present until the post-exposure. The binder resin is preferably well compatible with the cation-polymerizable compound as well as the radical-polymerizable composition, and typically includes chlorinated polyethylene, polymethyl methacrylate, copolymers of methyl methacrylate with other alkyl (meth)acrylates, copolymers of vinyl chloride with acrylonitrile, and polyvinyl acetate. The binder resin could have cation-polymerizable or other reactive groups in its side or main chain.

The photosensitive composition may contain, per total weight, 2 to 70% by mass, preferably 10 to 50% by mass of the cation-polymerizable compound, 30 to 90% by mass, preferably 40 to 70% by mass of the radical-polymerizable compound, 0.3 to 8% by mass, preferably 1 to 5% by mass of the photoradical polymerization initiator system, and 0.3 to 8% by mass, preferably 1 to 5% by mass of the photocation polymerization initiator system.

The photosensitive composition is composed of, based on its total mass, 2% by mass to 70% by mass, preferably 10% by mass to 50% by mass of the cation-polymerizable compound, 30% by mass to 90% by mass, preferably 40% by mass to 70% by mass of the radical-polyemerizable compound, 0.3% by mass to 8% by mass, preferably 1% mass to 5% by mass of the cation-polymerization initiator system, and 0.3% by mass to 5% by mass, preferably 1% by mass to 5% by mass of the radical polymerization initiator system. The photosensitive composition is prepared by blending together the essential components and optional components with or without a solvent added to them if required, such as a ketone solvent like methyl ethyl ketone, an ester solvent like ethyl acetate, an aromatic solvent like toluene, a cellosolve solvent like methyl cellosolve, an alcoholic solvent like methanol, an ether solvent like tetrahydrofuran or dioxane, or a halogen solvent like dichloromethane or chloroform, and mixing the resulting blend at cool dark places, for instance, using a high-speed agitator.

The image transform layer comprising such a photosensitive composition may be formed by coating and drying the above photosensitive composition in the same manner as is the case with the above photosensitive composition (i). The amount of the photosensitive composition to be coated may be optionally selected in such a way as to give a post-drying thickness of, for instance, 1 μm to 50 μm.

In the thus prepared image transform layer, there are interference fringes recorded inside by irradiating it with laser light of,. e.g., 300 to 1,200 nm in wavelength to polymerize the radical-polymerizable compound. At this stage, there is diffracted light obtained from the recorded interference fringes, yielding a hologram. To further the polymerization of a portion of the cation- polymerizable compound remaining unreacted here, it is preferable that light of 200 to 700 nm in wavelength, to which the photo-cation polymerization initiator system is sensitive, is directed to all over the surface of the layer by the post-exposure to complete the hologram. Note here that if, prior to the post-exposure, the image transform layer is treated by heat or infrared radiation, then diffraction efficiency, the peak wavelength and half width of diffracted light, etc. may be varied.

Amplitude type diffractive optical element layer

When the above image transform layer is an amplitude type diffractive optical element layer, there is a black-and-white or other light-and-dark intensity distribution recorded in the above transmission Fourier transform hologram area of the image transform layer. Specifically, the image transform layer is formed using a photosensitive material such as a silver halide photosensitive material. Then, the portion of the image transform layer to become the transmission Fourier transform hologram area is irradiated with interference light of object light and reference light coming from a laser light source. Afterwards, a hologram is formed by development and fixation at the transmission Fourier transform hologram area.

The material usable for such an image transform layer, for instance, include photosensitive materials for silver halide photography such as those for silver halide photography, bichromated gelatin, and photosensitive materials using photosensitive resins. Among others, the silver halide photosensitive materials are particularly preferred for the present embodiment, because of being capable of providing an image transform layer that has high sensitivity, a broad spectral sensitivity distribution and high diffraction efficiency.

3. Transparent Substrate

The transparent substrate used herein is now explained. For the transparent substrate used herein, there is no critical requirement but to be capable of forming the above image transform layer and have optical transmission enough to transmit a light image formed at the transmission Fourier transform hologram area of the image transform layer. In particular, a transparent substrate having a transmittance of at least 80%, preferably at least 90% in a visible light range is most preferred. A lower transmittance would possibly cause disorder in light images obtained from the transmission Fourier transform hologram area in the present embodiment. Here, the transmittance of the transparent substrate may be measured according to JIS K7361-1 (Testing for the total transmittance of plastic—transparent materials).

The transparent substrate used herein is preferably reduced as much in haze as possible. Specifically, the haze value ranges preferably from 0.01% to 5%, more preferably from 0.01% to 3%, and most preferably from 0.01% to 1.5%. The haze value here is supposed to be a value measured according to JIS K7105.

No particular limitation is imposed on the material that forms the transparent substrate used herein with the proviso that it possesses such properties as mentioned above. For instance, plastic resins, and glass sheets maybe used. In the present embodiment, a plastic resin film is preferably used as the transparent substrate, because of being light weight, and having a little risk of breakdown, unlike glass.

For the resin that forms the above plastic resin film, there is no critical requirement but to have a rigidity high enough to support the above image transform layer. Exemplary such plastic resins are polyethylene terephthalate, polycarbonate, acrylic resins, cycloolefin resins, polyester resins, polystyrene resins and acrylstyrene resins with the polycarbonate being most preferred in consideration of double refraction. With ease of handling in mind, a thickness of about 0.05 to about 5 mm, preferably 0.1 to 3 mm is preferred.

4. Hologram Viewing Card

The hologram viewing card here is now explained. The hologram viewing card here comprises the above transparent substrate, the above image transform layer and the above receptor layer, and there is no critical limitation on it, provided that it is in a card form. The hologram viewing card here may be used in wide applications inclusive of business cards and membership cards as well as toys.

It is noted that the hologram viewing card here may have various prints applied onto the transparent substrate or the image transform layer, and images formed on the receptor layer in various modes including a sublimation heat transfer mode, an ink jet mode, a thermal transfer mode, and an intermediate transfer mode.

Here, when the above receptor layer is formed on the transparent layer, it is preferred that there is a primer layer interleaved between the transparent substrate and the receptor layer. This is because the adhesion between the transparent substrate and the receptor layer is so improved that a hologram viewing card of higher quality can be obtained.

For the above primer layer, there is no critical requirement but to make it possible to increase the adhesion between the receptor layer and the transparent substrate. For instance, the primer layer may be either transparent to visible light or printed in white or the like. The provision of the primer layer in white has an advantage of a surface printed on the receptor layer being easier to view. At a portion of the image transform layer stacked on the transmission Fourier transform hologram area, the primer layer is preferably transparent, so that a light image formed on the above transmission Fourier transform hologram area can be easy to view.

Such a primer layer, for instance, may be formed of a layer containing polyurethane, polyester, a polyvinyl chloride resin, a polyvinyl acetate resin, a vinyl chloride-vinyl acetate copolymer resin, an acrylic resin, a polyvinyl alcohol resin, a polyvinyl acetal resin, a copolymer of ethylene and vinyl acetate, acrylic acid or the like, and an epoxy resin.

The above primer layer may be formed by dissolving or dispersing the above resin in a suitable solvent into a coating solution, and coating and drying that coating solution in a known coating fashion. For the coating solution, the above resin may be used in combination with monomers, oligomers, prepolymers, etc. as well as reaction initiators, curing agents, crosslinking agents, coloring agents such as dyes and pigments, etc. Alternatively, a combination of the main components with the curing agent may be coated, dried, and aged if necessary, for reactions. The white pigment used for the primer layer, for instance, includes titanium oxide, zinc oxide, kaolin clay, calcium carbonate, fine silica, etc. which may be used alone or in combination of two or more.

The above primer layer has a thickness of usually about 0.05 μn to about 10 μm, preferably about 0.1 μm to about 5 μm.

In the present embodiment, too, the transmission Fourier transform hologram area of the image transform layer may have been provided thereon with such a protective layer as Explained later in the second embodiment of the invention.

B. Second Embodiment

Next, the second embodiment of the holographic viewing card of the invention is explained. The holographic viewing card of the second embodiment of the invention comprises a transparent substrate, an image transform layer formed on said transparent substrate and comprising a transmission Fourier transform hologram area having a Fourier transform lens function and a non-hologram area that is not included in said transmission Fourier transform hologram area and does not function as a Fourier transform lens, and a protective layer formed on said transmission Fourier transform hologram area of said image transform layer, characterized in that a printable receptor layer is formed on said protective layer.

As shown typically in FIG. 6, the holographic viewing card here comprises a transparent substrate 111, an image transform layer 112 formed on that transparent substrate 111 and at least comprising a transmission Fourier transform hologram area a and a non-hologram area b, a protective layer 114 formed on the transmission

Fourier transform hologram area a of that image transform layer 112, and a printable receptor layer 113 formed on that protective layer 114.

According to the present embodiment, the formation of the above receptor layer ensures the provision of a holographic viewing card capable of receiving various pieces of information and images by printing using various printers, etc. Generally, when printing is applied to a layer having a Fourier transform lens function, there are changes in the refractive index difference across the layer having a Fourier transform lens function, which render the formation of a light image difficult. According to the present embodiment wherein the above protective layer is provided and the above receptor layer is formed on that protective layer, however, printing can be applied to the receptor layer with no changes in the refractive index difference across the above transmission Fourier transform hologram. It is thus possible to obtain a holographic viewing card usable in various applications.

Further, the present embodiment, wherein the image transform layer comprising the above transmission Fourier transform hologram area is provided, has another advantage of being capable of efficiently fabricating holographic viewing cards with no need of applying or interleaving another transmission Fourier transform hologram. The respective components of the holographic viewing card here are now explained; however, the above transparent substrate and image transform layer will no longer be explained because of being substantially the same as in the above first embodiment.

1. Receptor Layer

The receptor layer used herein is first explained. For the receptor layer used herein and adapted to be formed on the protective layer (as will be described later), there is no critical requirement but to be printable. In the present embodiment, the receptor layer may be formed on at least the above protective layer. For instance, this layer may be formed on the protective layer in a patterned form, or all over the surface of the protective layer. Alternatively, the receptor layer may be formed just only on the protective layer but also on the surface of the transparent substrate that faces away from the image transform layer.

For the receptor layer, there is no particular requirement but to be printable as mentioned above, and there is no particular limitation on the type of printing, either. Most preferably in the present embodiment, the holographic viewing card is printable on demand and in a sublimation heat transfer mode, an ink jet mode, a thermal transfer mode, and an intermediate transfer mode. Such a receptor layer, because of being substantially the same as in above first embodiment, will not be explained any further.

2. Protective Layer

The protective layer used herein is now explained.

For the protective layer to be formed on at least the transmission Fourier transform hologram area of the above image transform layer, there is no critical requirement but to have functions of preventing contamination, etc. of the transmission Fourier transfer hologram area of the image transform layer, holding back changes in the refractive index difference across the transmission Fourier transform hologram area, etc. In the embodiment here, while the protective layer may be formed on the transmission Fourier transfer hologram area alone, it is understood that it may also be formed all over the surface of the image transform layer.

The protective layer used herein should transmit light diffracted by the above image transform layer, and so has preferably a high optical transmittance. Preferably in the embodiment here, the protective layer has a transmittance of at least 80%, especially at least 90% in a visible light range is most preferred. A lower transmittance would possibly cause disorder in light images obtained from the transmission Fourier transform hologram area in the present embodiment. Here, the transmittance of the protective layer may be measured according to JIS K7361-1 (Testing for the total transmittance of plastic—transparent materials).

The protective layer here is preferably reduced as much in haze as possible. Specifically, the haze value ranges preferably from 0.01% to 5%, more preferably from 0.01% to 3%, and most preferably from 0.01% to 1.5%. The haze value here is supposed to be a value measured according to JIS K7105.

For the material that forms the protective layer used herein, there is no critical requirement but to have the above properties. For such a material, both a rigid material having no flexibility, for instance, glass, and a material having flexibility may be used, although the flexible material is herein preferred. For instance, the use of the flexible material makes it possible to fabricate the holographic viewing card here by a roll-to-roll process, ensuring much higher productivity.

The above flexible material, for instance, may be thermoplastic resins represented by olefinic resins such as polyethylene resins, polypropylene resins, cyclic poly olefin resins, fluororesins, and silicone resins. Specific such thermoplastic resins are poly(meth)acrylic acid ester or its partial hydrolysate, polyvinyl acetate or its partial hydrolysate, polyvinyl alcohol or its partially acetallized product, triacetyl cellulose, polyisoprene, polybutadiene, polychloroprene, silicone rubber, polystyrene, polyvinyl butyral, polyvinyl chloride, polyarylate, chlorinated polyethylene, chlorinated polypropylene, poly-N-vinyl carbazole or its derivative, poly-N-vinyl pyrrolidone or its derivative, styrene-maleic anhydride copolymers or their half esters, and copolymers having as polymerization components at least one selected from the group of copolymerizable monomers such as acrylic acid, acrylic acid ester, acrylamide, acrylonitrile, ethylene, propylene, vinyl chloride and vinyl acetate. In the embodiment here, these thermoplastic resins may be used alone or in admixture of two or more.

The protective layer used herein may contain additives in such a range as to be not detrimental to its object and the above haze value. The additives are not critical, and so may be optionally selected depending on the application or the like of the holographic viewing sheet here. Such additives, for instance, include ultraviolet absorbers, infrared absorbers, water repellents, and fluorescent brighteners.

As long as the above protective layer has rigidity enough to prevent deformation by external disturbances from having adverse influences on the formation of the image transform layer to be described later, the thickness of the protective layer is not critical. Such a thickness may be optionally determined depending on the type of the component material of the protective layer; however, it is preferably in the range of usually 0.5 μm to 10 mm, especially 1 μm to 5 mm.

There is also no particular limitation on how to form the protective layer. For instance, the image transform layer and the protective layer may be put together with a spacer placed between them in such a way as to provide an air layer between the transmission hologram area of the image transform layer and the protective layer. Alternatively, such as when the protective layer has a certain refractive index difference with the image transform layer, the above resin material may be formed on the image transform layer to form the protective layer.

3. Holographic Viewing Card

The hologram viewing card here is now explained. The hologram viewing card here comprises the above transparent substrate, the above image transform layer, the above protective layer and the above receptor layer, and there is no critical limitation on it, provided that it is in a card form. For instance, the primer layer explained in conjunction with the first embodiment may be provided. The hologram viewing card here may be used in wide applications inclusive of business cards and membership cards as well as toys.

It is noted that the hologram viewing card here may have various prints applied onto the transparent substrate or the image transform layer, and images formed on the receptor layer in various modes including a sublimation heat transfer mode, an ink jet mode, a thermal transfer mode, and an intermediate transfer mode.

In this connection, the present invention is never limited to the embodiments as described above. Those embodiments are provided by way of example alone, and so any arrangements substantially equivalent to the technical concept recited in the claims and having equivalent advantages are understood to be encompassed in the technical breadth of the invention.

### EXAMPLE

### Example 1

### Formation of the Image Transform Layer

A dry etching resist was spin coated on a chromium thin film of a photomask blank plate wherein the chromium thin film of low surface reflection was laminated on a synthetic quartz substrate, using a spinner. For the dry etching resist, ZEP7000 (made by Nippon Zeon Co., Ltd.) was formed at a thickness of 400 nm. An electron beam lithographic system (MEBES 4500 made by ETEC Co., Ltd.) was used with the resist layer to expose a previously computer-generated pattern to light, thereby making the exposed portion of the resist resin readily dissolvable. Afterwards, a developing solution was sprayed onto the readily dissolvable portion (spray development) for its removal, thereby preparing a resist pattern.

Subsequently, using the formed resist pattern, a non-resist portion of the chromium thin film was etched out by drying etching to expose the quartz substrate. Then, the exposed quartz substrate was etched to form a concave portion in it. Thereafter, the resist thin film was dissolved out to obtain an original plate having a concave portion resulting from etching of the quartz substrate and a convex portion resulting from the quartz substrate and chromium thin film remaining unecthed.

An image transform layer-formation composition (UV curing acrylate resin having a refractive index of 1.52 as measured at 633 nm wavelength) was added as droplets onto the original plate having such concave and convex portions, and a 0.5 mm-thick polycarbonate substrate (transparent substrate) was placed down onto that composition. After the image transform layer-formation composition was cured by irradiation with active radiation, it was released off to prepare a transparent substrate provided with an image transform layer having a rugged image in which the rugged pattern on the-original plate was flipped over. A portion to become a non-hologram area was configured in a planar shape.

### Formation of the Protective Layer

As a combined spacer and adhesive, a coating solution (CAT-1300S made by Teikoku Ink Co., Ltd.) was patterned by screen printing onto an acryl plate (a 2 mm-thick “Paraglass” made by Kurare Co., Ltd.), and release paper was applied onto the printed surface to prepare a protective layer-formation member. Note here that the combined spacer and adhesive was patterned on a portion to become the non-hologram area.

Subsequently, the release paper was peeled off the above protective layer-formation member, and the protective layer was forced against, and put on, the rugged surface of the transparent substrate having an image transform layer. The assembly was punched out to a given size (5 cm×5 cm).

### Formation of the Receptor Layer Printable in a Sublimation Heat Transfer Mode

### Composition of the Receptor Layer-formation Ink

| | |
|---|---|
| Polyester resin (Bylon 200 made by Toyobo | 100 parts by weight |
| Co., Ltd.) | |
| Hydroxyl group modified silicone resin (X-62- | 4 parts by weight |
| 1421B made by Shinetsu Silicone Co., Ltd.) | |
| Isocyanate curing agent (Takenate A14 made by | 4 parts by weight |
| Mitsui Takeda Chemical Co., Ltd.) | |
| Solvent (toluene/methyl ethyl ketone = 1/1) | 100 parts by weight |

By means of a bar coater, the receptor layer-formation ink having the above composition was coated all over the surface of the transparent substrate that faced away from the above image transform layer, and then dried at 110° C. for 3 minutes. The post-drying thickness of the receptor layer was then 5 μm.

### Estimation

With a sublimation type card printer DTC300 (made by Fargo Co., Ltd.), an image was printed on the obtained holographic viewing card. It was found that the image was clearly formed, and that upon viewing a point light source through the transmission Fourier transform hologram area, a transformed image was seen.

### Example 2

### Formation of the Image Transform Layer and the Protective Layer

As in Example 1, an image transform layer and a protective layer were formed on a transparent substrate.

### Formation of the Primer Layer and the Receptor Layer Printable in a Sublimation Heat Transfer Mode Composition of the Primer Layer-formation Ink

Polyurethane resin (N-5247 made by Nippon Polyurethane Co., Ltd.) 100 parts by weight
Titanium oxide particles (A-150 made by Skai Chemical Co., Ltd.) 150 parts by weight
Solvent (toluene/methyl ethyl ketone/IPA=1/1/1) 100 parts by weight

By means of a bar coater, the primer layer-formation ink having the above composition was coated all over the surface of the transparent substrate that faced away from the above image transform layer, except for the hologram area, and then dried at 110° C. for 3 minutes. The post-drying thickness of the receptor layer was then 3 μm. Subsequently, the receptor layer printable in a sublimation heat transfer mode was formed on the primer layer as in Example 1, thereby obtaining a holographic viewing card.

### Estimation

With a sublimation type card printer DTC300 (made by Fargo Co., Ltd.), an image was printed on the obtained holographic viewing card. It was found that the image was more clearly seen as compared with Example 1, and that upon a viewing point light source through the transmission Fourier transform hologram area, a transformed image was seen.

### Example 3

### Formation of the Image Transform Layer and the Protective Layer

An image transform layer and a protective layer were formed on a transparent substrate as in Example 1.

### Formation of the Receptor Layer Printable in a Thermal Transfer Mode, and an Intermediate Transfer Mode Composition of the Receptor Layer-formation Ink

| | |
|---|---|
| Polyester resin (Bylon 200 made by Toyobo | 100 parts by weight |
| Co., Ltd.) | |
| Solvent (toluene/methyl ethyl ketone = 1/1) | 100 parts by weight |

By means of a bar coater, the receptor layer-formation ink having the above composition was coated all over the surface of the transparent substrate that faced away from the above image transform layer, and then dried at 110° C. for 3 minutes. The post-drying thickness of the receptor layer was then 5 μm.

### Estimation

With a thermal type card printer CP300 (made by Toppan Printing Co., Ltd.), and an intermediate transfer type card printer CX-210 (Dai Nippon Printing Co., Ltd.), an image was printed on the obtained holographic viewing card. It was found that the images were clearly formed, and that upon viewing a point light source through the transmission Fourier transform hologram area, a transformed image was seen.

### Example 4

### Formation of the Image Transform Layer and the Protective Layer

An image transform layer and a protective layer were formed on a transparent substrate as in Example 1.

### Formation of the Receptor Layer Printable in an Ink Jet Mode

### Composition of the Receptor Layer-formation Ink

| | |
|---|---|
| Pateracoal IJ2 (made by Dai Nippon Ink Co., Ltd.) | 100 parts by weight |
| Solvent (water) | 30 parts by weight |

By means of a bar coater, the receptor layer-formation ink having the above composition was coated all over the surface of the transparent substrate that faced away from the above image transform layer, and then dried at 110° C. for 3 minutes. The post-drying thickness of the receptor layer was then 20 μm.

### Estimation

With an ink jet printer PM-900 (made by Epson Co., Ltd.), an image was printed on the obtained holographic viewing card. It was found that the image was clearly formed, and that upon viewing a point light source through the transmission Fourier transform hologram area, a transformed image was seen.

Reference is then made to another hologram usable as the transmission Fourier transform hologram in the inventive holographic viewing device and card of FIGS. 1-4, FIG. 6, etc.

In a holographic viewing device using that another hologram, Nₓ, N_{y}, Wₓ and W_{y} in input data for a character string recorded in a computer-generated hologram constructed as a transmission Fourier transform hologram that enables a given character string to be reconstructed and viewed near the positions of point light sources upon viewing the point light sources through the hologram are determined in such a way as to come within a given range, so that the character string can be viewed, with good image quality, in place of limited extent point light sources or while overlapping them. Here, Nₓ and N_{y} are the numbers of input data pixels in the horizontal and vertical directions, respectively, and Wₓ and W_{y} are the recording sizes of pixels in the horizontal and vertical directions, respectively, of the computer-generated hologram with the input data for that character string recorded in it.

The principles of the holographic viewing device using that another hologram are now explained with reference to the drawings.

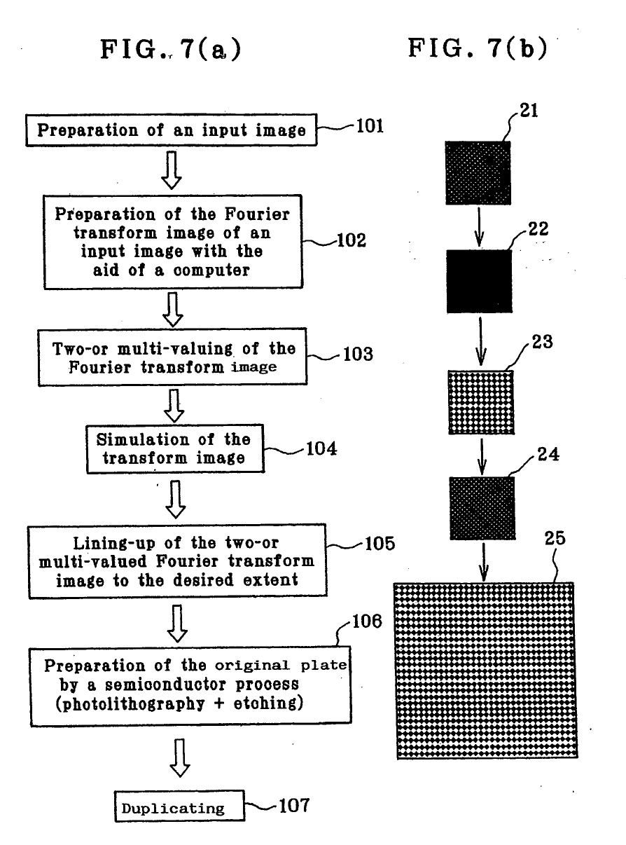

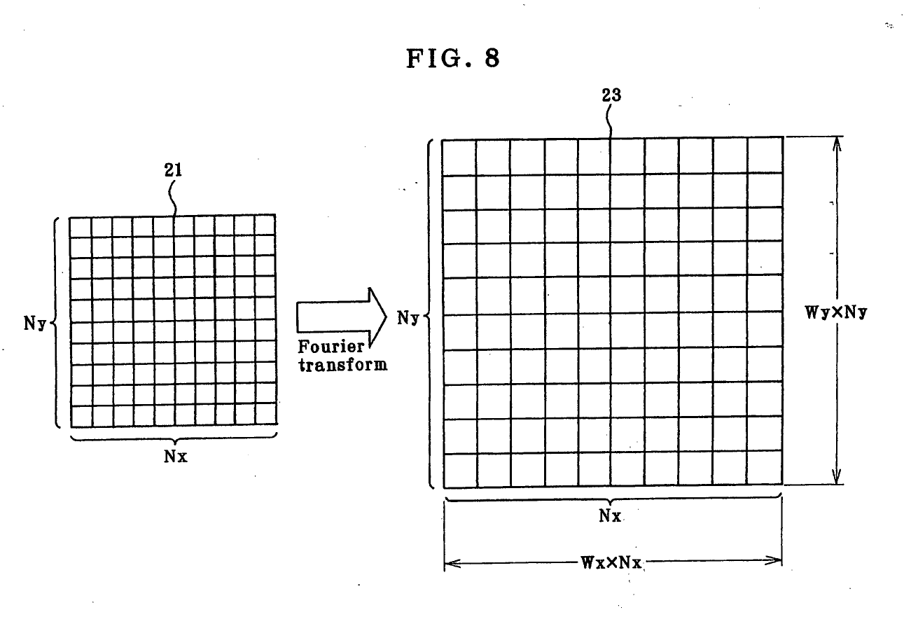

According to the present invention, relations of the number of pixels Nₓ and N_{y} in an input image 21 of FIG. 7(b) to the recording sizes Wₓ and W_{y} of pixels in a Fourier transform image 23 obtained by multi-valuing the Fourier transform image 22 of the input image 21 (hereinafter called the unit computer-generated hologram 23) are so determined that a reconstructed image of a character string can be viewed with image quality enough to be clearly read with the desired resolving power. FIG. 8 is illustrative in schematic of relations of the input image 21 to the pixels of the unit computer-generated hologram 23. The input image 21 has a Fourier transform relation to the unit computer-generated hologram 23; given Nₓ and N_{y} indicative of the number of pixels in the input image 23 in the horizontal and vertical directions, respectively, the number of pixels in the horizontal and vertical directions of the unit computer-generated hologram 23 becomes Nₓ and N_{y}, the same as the number of pixels of the input image 21. And, given Wₓ and W_{y} indicative of the recording sizes of pixels in the horizontal and vertical directions, respectively, of the unit computer-generated hologram 23, the horizontal and vertical sizes of the unit computer-generated hologram 23 become Wₓ×Nₓ and W_{y}×N_{y}, respectively.

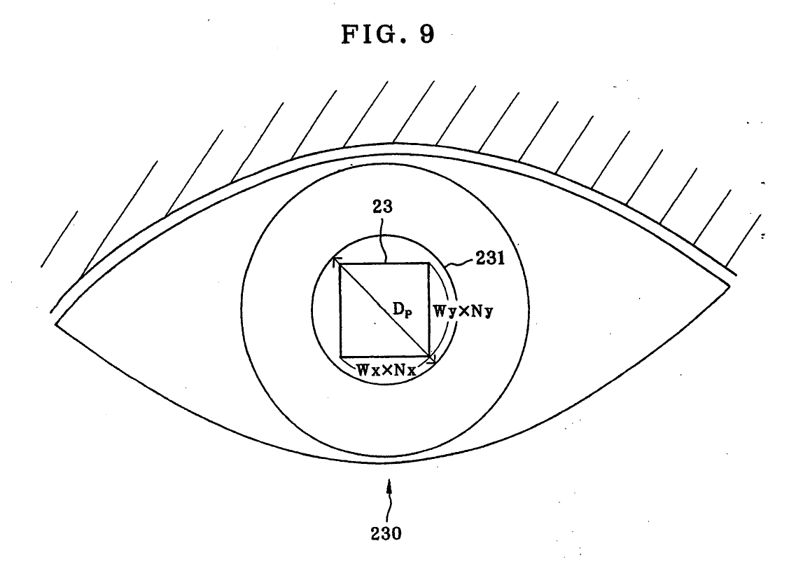

FIG. 9 is illustrative in schematic of, upon viewing the inventive holographic viewing device with a human eye 230 , in what relation the pupil 231 of the eye 230 is to the unit computer-generated hologram 23 for the computer-generated hologram 23 forming part of the holographic viewing device. If the unit computer-generated hologram 23, which is repeatedly lined up in the horizontal and vertical directions of the computer-generated hologram 25, is of such a size as to come within the diameter Dₚ of the pupil 231 of the eye 230, then the input image 21 is visible to the human eye in a fully reconstructed state. Conversely, if the unit computer-generated hologram 23 is of such a size as to be larger than the diameter Dₚ of the pupil 231 of the eye 230 or be shaded by the pupil 231, then there is a decrease in the number of pixels of the unit computer-generated hologram 23 coming within the human eye, resulting in a decrease in the number of pixels of a reconstructed image matching with the inverse Fourier transform image and, hence, a drop of resolving power.

Given a square unit computer-generated hologram 23, therefore, it is a condition for viewing a recorded image with sufficient resolving power to satisfy conditions (1) and (2).
Wₓ×Nₓ≦Dₚ/√2 (1)
W_{y}×N_{y}≦Dₚ/√2 (2)
Here, if Dₚ=4 mm is set as a typical size because the diameter Dₚ of the pupil of the human eye dilates (about 8 mm) in the dark and dwindles (about 2 mm) in the bright, conditions (1) and (2) become:
Wₓ×N_{y}≦Dₚ/√2=2.828 (mm) (1′)
W_{y}×N_{y}≦Dₚ/√2=2.828 (mm) (2′)
That is, for the purpose of viewing an image recorded in the computer-generated hologram 25 with sufficient resolving power, it would appear to be necessary to satisfy conditions (1′) and (2′).

Consider now the case where a character string image is recorded as the input image 21 in the computer-generated hologram 25 (the unit computer-generated hologram 23), and an image 24 is reconstructed from the computer-generated hologram 25. There is a condition about the size (angle) of the reconstructed image, at which each character of the input image is perceptible.

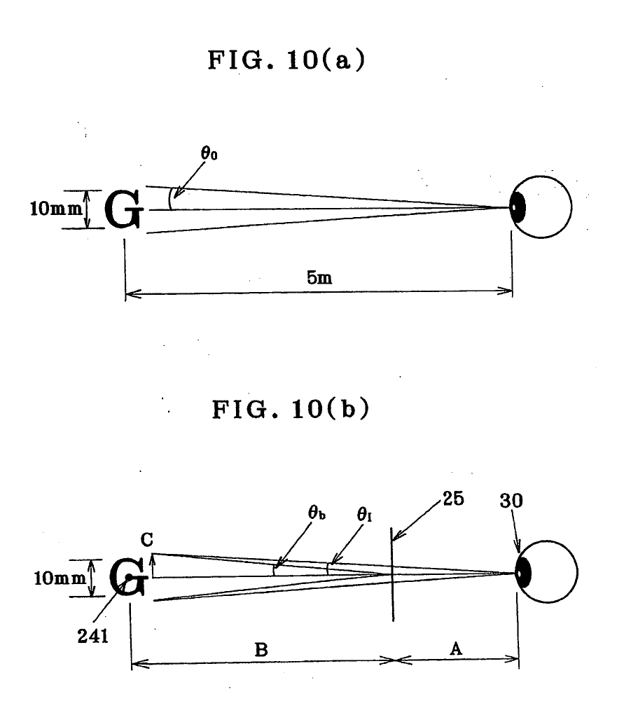

Consider then the viewing of a character “G” having a plurality of different heights from a distance of 5 m. The results of experimentation show that a person with a visual power of 1.5 could recognize that character as “G”, given character heights of 10 mm or greater. Here, let 2θ₀ be the angle subtended by the character “G”. In view of FIG. 10(a),
θ₀=arctan (5 mm/5000 mm)≈0.001 [rad] (3)

When characters are viewed while they are lined up, the angle subtended by the whole character string grows large nearly proportionally to the number of characters.

Now let NTₓ be the number of characters in the character string in the horizontal direction, and 2θₓ be the angle subtended by the whole character string in the horizontal direction. Here, if 2θₓ satisfies the following condition, one could then recognize each of the characters that form the character string.
θₓ≦NTₓ×θ₀=0.001×NTₓ[rad] (4)

In view of FIG. 10(b), on the other hand, the angle 2θ₁ subtended by a pattern viewed through the computer-generated hologram 25 of the holographic viewing device is determined as follows:
C=B tan θ_{b} (5)
where Pₓ is the minimum grating space included in the hologram pattern of the computer-generated hologram 25, λ is a wavelength, B is the distance between a point light source 241 (corresponding to light sources 4, 5, 6, 7) and the computer-generated hologram 25, and A is the distance between the computer-generated hologram 25 and the eye 230 of a viewer.

Here, C is ½ of the height of the pattern (the character “G” in FIG. 10(b)) reconstructed near the point light source 241, and θ_{b} is ½ of the angle subtended at the computer-generated hologram 25 by that pattern.

From the diffraction equation, there is a relation:
Pₓ=λ/sin θ_{b} (6)
From this equation (6),
θ_{b}=arc sin (λ/Pₓ) (7)
On the other hand, there is a relation:
tan θ₁=C/(A+B) (8)
Use of equations (5) and (7) gives
θ₁=arc tan[B tan{arc sin(λ/Pₓ)}/(A+B)]≈Bλ/Pₓ(A+B)[rad] (9)

Further, because B>>A in an ordinary mode of use, from equation (9),
θ₁≈λ/Pₓ (10)

Accordingly, if the angle 2θ₁ subtended by the pattern viewed through the computer-generated hologram 25 satisfies condition (4) for the angle 2θₓ subtended by the whole character string in the horizontal direction, one can then recognize the character string viewed through the computer-generated hologram 25. That is,
θ₁≦0.001×NTₓ[rad] (11)
Accordingly, use of equation (10) gives
Pₓ≦λ/(0.001×NTₓ) (12)
To express the minimum grating space Pₓ in terms of a set of pixels, the minimum grating space Pₓ is desirously composed of at least four pixels (to express a diffraction grating of sin wave shape in section, a minimum of four pixels are needed). That is, because the recording size of one pixel is Wₓ, the condition under which each of the characters that form the character string viewed through the computer-generated hologram 25 can be recognized is
Wₓ≦λ/(4×0.00×NTₓ)=λ/(0.004×NTₓ) (13)
The foregoing discussions are about the horizontal direction. In the vertical direction, too,
W_{y}≦λ/(0.004×NT_{y}) (14)
where NT_{y} is the number of characters in the character string in the vertical direction.

Then, consider an input character string image that is recorded as the input image in the computer-generated hologram 25 (unit computer-generated hologram). In order to have that string recognized as characters, a given condition is needed about the size (the number of pixels) of the input image 21, at which the characters are individually recognizable.

When the hologram for the holographic viewing device is fabricated of the computer-generated hologram 25, the image to be viewed through that holographic viewing device must be drawn in terms of a set of pixels (the input image 21 in FIG. 8). Therefore, when the image to be viewed is a character string, too, it is required to draw each character as a set of pixels. When alphabets are thought of as the input characters, at least 5 pixels in a row and at least 5 pixels in a column are needed; otherwise, it is impossible to tell a total of 26 alphabets apart. In order that the image to be viewed is configured in a character string form, characters, each of 5 pixels×5 pixels, are lined up to make a character string image 21. In order to line up the characters, each 5 pixels×5 pixels, into a character string image, indeed, there is a one-pixel space needed between characters; that is, the number of pixels necessary for each character is 6 pixels ×6 pixels.

Here let NTₓ be the number of characters lined up in the horizontal direction, and NT_{y} be the number of characters lined up in the vertical direction. Then, the number of pixels NIₓ, NI_{y} at which the character string image is regarded as a set of characters is
NIₓ≦6×NTₓ (15)
NI_{y}≦6×NT_{y} (16)

Upon viewing the computer-generated hologram 25 of the holographic viewing device, on the other hand, a higher-order diffracted image having the same pattern as the desired reconstruction image is reconstructed around the image reconstruction area. For this reason, it is not preferred that an image viewed as the image reconstructed from the computer-generated hologram 25 is located nearly all over the area of the input image in the computer-generated hologram 25, because a higher-order diffracted image reconstructed around the desired reconstruction pattern (the character string in this case) is way too close to the desired pattern, growing noticeable and obtrusive. It is thus desired that the pattern to be viewed is located within ½ of the middle portion of the input image 21, both in the row direction and the column direction.

With the foregoing discussion further in mind, the number of pixels Nₓ and N_{y} in the horizontal and vertical directions, respectively, of the input image 21 for reconstructing the character string as the image reconstructed from the computer-generated hologram 25 of the holographic viewing device must satisfy the following condition.
Nₓ≦2×NIₓ≦12×NTₓ (17)
N_{y}≦2×NI_{y}≦12×NT_{y} (18)

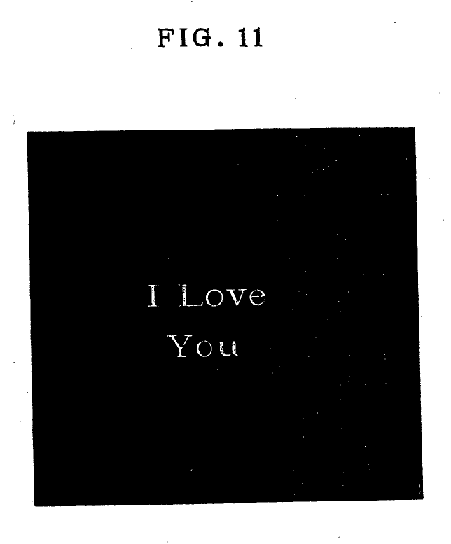

One example of the holographic viewing device using another hologram is now explained. There was a computer-generated hologram 25 fabricated, which was used with a holographic viewing device capable of viewing such a character string “I Love You” as depicted in FIG. 11 in place of point light sources in a scene (light sources 4, 5, 6, 7 in FIG. 12).

The number of characters NTₓ of the input image in the horizontal direction is six “I Love” in the upper row that is more than “You” in the lower row: NTₓ=6. Here, a “space” between the “I” and “Love” is also counted as one. The number of characters NTY in the vertical direction is a total of two columns “I Love” and “You”: NT_{y}=2. Note that the hologram-to-point light sources distance is B=2 m and the wavelength λ of the point light sources is 550 nm.

If the number of pixels Nₓ and N_{y} in the horizontal and vertical directions, respectively, of the input data in the computer-generated hologram 25 and the recording sizes of pixels Wₓ and W_{y} in the computer-generated hologram 25 in the horizontal and vertical directions, respectively, are set in the following ranges on the basis of conditions (1′), (2′), (13), (14), (17) and (18), it is then possible to achieve a holographic viewing device that has such conditions as mentioned above and view a character string of good image quality.
Wₓ×Nₓ≦2.828(mm)
W_{y}×N_{y}≦2.828(mm)
Wₓ≦λ/(0.004×NTₓ)=0.55 μm/(0.004×6)=22.916 μm
W_{y}≦λ/(0.004×NT_{y})=0.55 μm/(0.004×2)=68.75 μm
N_{y}≦12×NT_{y}=12×6=72
N_{y}≦12×NT_{y}=12×2=24

Within the ranges described above, Wₓ, W_{y}, Nₓ and N_{y} were set as mentioned below to fabricate the computer-generated hologram 25 for the holographic viewing device.

As a result, a character string of good image quality could be viewed as in FIG. 11.
Wₓ=2 μm
W_{y}=5 μm
Nₓ=256
N_{y}=256
Wₓ×Nₓ=1.28 mm
W_{y}×N_{y}=1.28 mm

While some embodiments of the holographic viewing device according to the invention and the holographic viewing card using it have been explained, it is to be understood that the prevent invention is never limited to them, and many modifications could be possible.

What we claim is:

1. A holographic viewing device that enables a given image or message to be viewed near positions of point light sources upon viewing the point light sources through a hologram, which has a structure including a transparent substrate, a hologram-formation layer and a printing layer.

2. The holographic viewing device according to claim 1, where said hologram-formation layer comprises a phase type diffractive optical element having a relief structure on a surface thereof.

3. The holographic viewing device according to claim 1, wherein said hologram-formation layer comprises a phase type diffractive optical element having a refractive index profile in a layer thereof.

4. The holographic viewing device according to claim 1, wherein said hologram-formation layer comprises an amplitude type diffractive optical element having a transmittance profile in a layer thereof.

5. The holographic viewing device according to claim 2, wherein said hologram-formation layer comprises any one of a thermosetting resin, a thermoplastic resin, an ultraviolet curable resin, and an electron beam curable resin.

6. The holographic viewing device according to any one of claims 1 to 5, wherein said printing layer faces away from said hologram-formation layer with respect to said transparent substrate.

7. The holographic viewing device according to any one of claims 1-6, wherein said printing layer faces away from a viewing side with respect to said transparent substrate.

8. The holographic viewing device according to any one of claims 1-7, wherein said hologram-formation layer is provided thereon with a protective layer.

9. The holographic viewing device according to any one of claims 1-8, wherein said printing layer is provided thereon with a message write layer.

10. The holographic viewing device according to claim 9, wherein said message write layer is provided thereon with a protective layer for protection of a portion of that layer which is spared.

11. A holographic viewing card, comprising the holographic viewing device according to any one of claim 1-10.

12. A holographic viewing card comprising a transparent substrate, and an image transform layer formed on said transparent substrate and comprising a transmission Fourier transform hologram area that enables a given image or message to be viewed near positions of point light sources upon viewing the point light sources through a hologram and a non-hologram area that is not included in said transmission Fourier transform hologram area and does not function as a Fourier transform lens, wherein a printable receptor layer is formed on the side of said transparent substrate that faces away from said image transform layer or on said non-hologram area of said image transform layer.

13. The holographic viewing card according to claim 12, a primer layer is formed between said transparent layer and said receptor layer.

14. The holographic card according to claim 13, wherein said primer layer contains a white pigment.

15. A holographic viewing card, comprising a transparent substrate, an image transform layer comprising a transmission Fourier transform hologram area that enables a given image or message to be viewed near positions of point light sources upon viewing the point light sources through a hologram and a non-hologram area that is not included in said transmission Fourier transform hologram area and does not function as a Fourier transform lens, and a protective layer formed on said transmission Fourier transform hologram area of said image transform layer, wherein a printable receptor layer is formed on said protective layer.

16. The holographic viewing card according to any one of claims 12-15, wherein an image has been printed on said receptor layer in a thermal heat transfer mode.

17. The holographic viewing card according to any one of claims 12-15, wherein an image has been printed on said receptor layer in an ink jet mode.

18. The holographic viewing card according to any one of claims 12-15, wherein an image has been printed on said receptor layer in a thermal transfer mode.

19. The holographic viewing card according to any one of claims 12-15, wherein an image has been printed on said receptor layer in an intermediate transfer mode.

20. The holographic viewing card according to any one of claims 12-19, wherein said image transform layer is a surface phase type diffractive optical element layer wherein said transmission Fourier transform hologram area has a relief structure on a surface thereof.

21. A hologram viewing device, comprising a computer-generated hologram constructed as a transmission Fourier transform hologram such that a given character string is reconstructed and viewed near positions of point light sources upon viewing the point light sources through a hologram, which satisfies the following relations with respect to Nₓ, N_{y}, Wₓ and W_{y} where Nₓ is a number of pixels in a horizontal direction of input original image data recorded in said computer-generated hologram, N_{y} is a number of pixels in a vertical direction of the input original image data recorded in said computer-generated hologram, Wₓ is a recording size of pixels of said computer-generated hologram in a horizontal direction, and W_{y} is a recording size of pixels of said computer-generated hologram in a vertical direction:
Wₓ×Nₓ≦2.828(mm) (1′)
W_{y}×N_{y}≦2.828(mm) (2′)
Wₓ≦π/(0.004×NTₓ) (13)
W_{y}≦λ/(0.004×NT_{y}) (14)
where λ is a wavelength of the point light sources, NTₓ is a number of characters in the character string in a horizontal direction, and NT_{y} is a number of characters in the character string in a vertical direction.

22. The holographic viewing device according to claim 21, where the number of pixels Nₓ and N_{y} in the horizontal and vertical directions of the input original image data recorded in said computer-generated hologram satisfies the following relation:
Nₓ≦12×NTₓ (17)
N_{y}≦12×NT_{y} (18)

23. The holographic viewing device according to claim 21 or 22, wherein in said computer-generated hologram, unit computer-generated holograms, each comprising a Fourier transform image of the input original image, are lined up in given numbers in the horizontal and vertical directions.
